(19) United States
(12) Patent Application Publication
(10) Pub. No.: US 2024/0043666 A1
(43) Pub. Date: Feb. 8, 2024

(54) POLYETHYLENE RECYCLATE BLEND PRODUCTS

(71) Applicant: Equistar Chemicals, LP, Houston, TX (US)

(72) Inventors: Sameer D. Mehta, Mason, OH (US); Harilaos Mavridis, Lebanon, OH (US)

(73) Assignee: Equistar Chemicals, LP, Houston, TX (US)

(21) Appl. No.: 18/227,011

(22) Filed: Jul. 27, 2023

Related U.S. Application Data
(60) Provisional application No. 63/395,255, filed on Aug. 4, 2022.

(51) Int. Cl. C08L 23/06

(52) U.S. Cl. CPC C08L 23/06; C08L 2207/062; C08L 2205/025; C08L 2207/20; C08L 2201/08

(57) ABSTRACT

Compositions comprising a blend of a first HDPE component having a relatively higher density and lower molecular weight and a second HDPE component, having a relatively lower higher density and higher molecular weight, are provided. The blends demonstrate improved ESCR performance relative to currently available HDPE products at a given density.

### CROSS-REFERENCE TO RELATED APPLICATIONS

This application claims the benefit of priority to U.S. Provisional Application No. 63/395,255 filed on Aug. 4, 2022, which is incorporated herein by reference in its entirety.

### FIELD OF THE INVENTION

The present disclosure relates to blends of a high density polyethylene recyclate with a virgin high density polyethylene.

### BACKGROUND OF THE INVENTION

Polyolefins, in particular polyethylene, are increasingly consumed in large amounts for many applications, including packaging for food and other goods, electronics, automotive components, and a great variety of manufactured articles. Large amounts of waste plastic materials are presently coming from differential recovery of municipal plastic wastes, mainly constituted of flexible packaging (cast film, blown film and BOPP film), rigid packaging, blow molded bottles and injection molded containers. Usually, through a step of separation from other polymers, such as PVC, PET or PS, polyethylene fractions, in particular, high density polyethylene (HDPE) recyclate can be recovered.

Applications for use of HDPE resins commonly include, but are not limited to, small blow-molding, caps and closures, jerry cans, high molecular weight films, injection molding, conduit, industrial bulk containers, and the like. Direct reuse of such HDPE recyclate is typically limited in that these materials suffer from a loss of cracking resistance, melt strength, and/or impact strength relative to virgin HDPEs having similar density and high load melt index. Thermally and/or catalytically degrading polymer recyclate allows for recovery of the monomeric building blocks of polymers as feedstock for manufacture of new polymers with the desired properties. However, this requires additional processing steps that are energy intensive and, in some instances, result in the generation of undesirable byproducts requiring yet more processing steps for desirable disposition of such byproducts.

It would be desirable to more directly place HDPE recyclate back into the stream of commerce while minimizing the additional processing steps required to do so. There is a need to provide processes to produce HDPE compositions comprising recycled HDPE, such HDPE compositions having a useful combination of properties that are equal to or better than analogous virgin HDPE compositions. Ideally, such processes would be highly flexible and could be implemented with commonly used equipment and familiar techniques to produce a wide variety of products.

### SUMMARY OF THE INVENTION

In general, the present disclosure relates to compositions comprising a blend of a first HDPE component and a second HDPE component. The first HDPE component has a relatively lower molecular weight and higher density than the second HDPE component. In some embodiments, the blends have a higher environmental stress cracking resistance (ESCR) than virgin HDPEs having a similar density.

In some embodiments, the first HDPE component is present in the blend in an amount in the range of from 40 wt. % to 95 wt. %, and the second HDPE component is present in the blend in an amount in the range of from 5 wt. % to 60 wt. %, wherein weight percentages are based on the total weight of first HDPE component and the second HDPE component.

In some embodiments, the first HDPE component has a density in the range of from g/cm³ to 0.965 g/cm³ , a melt index (Is) in the range of from 1.50 g/10 min. to 3.50 g/10 min., and an environmental stress crack resistance (“ESCR”) F50 in the range of from 10 hours to less than 20 hours in 10% Igepal.

In some embodiments, the second HDPE component has a density in the range of from g/cm³ to 0.954 g/cm³, a melt index (I₅) in the range of from 0.10 g/10 min. to 1.50 g/10 min., and an environmental stress crack resistance (“ESCR”) F50 greater than or equal to 1,000 hours in 10% Igepal.

In some embodiments, the blend has a density in the range of from 00.951 g/cm³ to g/cm³, a melt index (I₅) in the range of from 0.60 g/10 min. to 2.50 g/10 min., and an environmental stress crack resistance (“ESCR”) F50 in the range of from 24 hours to 1,000 hours in 100% Igepal and/or from 24 hours to 84 hours in 10% Igepal.

In some embodiments, the composition is produced by melt blending the first and second HDPE components, and optionally primary and/or secondary antioxidants, to form a pelletized product.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing other film structures and/or processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### BRIEF DESCRIPTION OF THE FIGURES

The claimed subject matter may be understood by reference to the following description taken in conjunction with the accompanying drawings, in which like reference numerals identify like elements, and in which:

FIG. 1 shows overlaid graphs of ESCR performance of HDPE blends according to embodiments of the invention compared to other similar HDPE blends;

FIG. 2 shows ESCR performance of blends disclosed herein using a virgin first HDPE component compared to other HDPEs; and

FIG. 3 shows ESCR performance of blends disclosed herein using a recyclate first HDPE component compared to other HDPEs; and

FIG. 4 shows diameter swell performance of HDPE blends according to embodiments of the invention relative to benchmark diameter swell range.

While the disclosed process and composition are susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

“Antioxidant agents,” as used herein, means compounds that inhibit oxidation, a chemical reaction that can produce free radicals and chain reactions. Antioxidants are differentiated based on their reaction mechanisms and include: (1) primary antioxidants, and (2) secondary antioxidants.

“Compounding conditions,” as used herein, means temperature, pressure, and shear force conditions implemented in an extruder to provide intimate mixing of two or more polymers and optionally additives to produce a substantially homogeneous polymer product.

“HDPE recyclate,” as used herein, means a portion of polyolefin recyclate having a density in the range of 0.940 g/cm³ to 0.970 g/cm³.

“HDPE,” as used herein, means ethylene homopolymers and ethylene copolymers produced in a gas phase and/or slurry phase polymerization and having a density in the range of g/cm³ to 0.970 g/cm³.

“Polyolefin recyclate,” as used herein, means post-consumer recycled (“PCR”) polyolefin and/or post-industrial recycled (“PIR”) polyolefin. Polyolefin recyclate is derived from an end product that has completed its life cycle as a consumer item and would otherwise be disposed of as waste (e.g., a polyethylene water bottle) or from plastic scrap that is generated as waste from an industrial process. Post-consumer polyolefins include polyolefins that have been collected in commercial and residential recycling programs, including flexible packaging (cast film, blown film and BOPP film), rigid packaging, blow molded bottles, and injection molded containers. Usually, through a step of separation from other polymers, such as nylon, polyamides, PVC, PET or PS, two main polyolefinic fractions are obtained, namely polyethylene recyclate (including HDPE, MDPE, LDPE, and LLDPE) and polypropylene recyclate (including homopolymers, random copolymers, and heterophasic copolymers). Polyethylene recyclate can be further separated to recover a portion having polyolefin as the primary constituent. In addition to contamination from dissimilar polymers, polyolefin recyclate frequently contains other impurities such as PMMA, PC, wood, paper, textile, cellulose, food, and other organic wastes, many of which cause the polyolefin recyclate to have an unpleasant odor before and after typical processing.

“Primary antioxidants,” as used herein, means compounds which function essentially as free radical terminators or scavengers. Primary antioxidants react rapidly with peroxy and alkoxy radicals. The majority of primary antioxidants for polymers are sterically hindered phenols.

“Processability,” as used herein, refers to how well a polymer composition can be formed into a cast of blown film of commercial quality or molded by injection or compression molding into a molded article of commercial quality at commercially acceptable rates using the equipment and conditions.

“Secondary antioxidants,” as used herein, means compounds which are preventive antioxidants that function by retarding chain initiation. Secondary antioxidants react with hydroperoxides to yield non-radical products and are, therefore, frequently called hydroperoxide decomposers.

“Virgin HDPE,” as used herein, are pre-consumer HDPEs. Pre-consumer HDPEs are products obtained directly or indirectly from petrochemical feedstocks fed to a polymerization apparatus. Pre-consumer polyolefins can be subjected to post polymerization processes such as, but not limited to, extrusion, pelletization, peroxidation, visbreaking, and/or other processing completed before the product reaches the end-use consumer. In some embodiments, virgin polyolefins have a single heat history. In some embodiments, virgin polyolefins have more than one heat history. In some embodiments, virgin polyolefins comprise no additives. In some embodiments, virgin polyolefins comprise additives.

### HDPE Blend Compositions

Disclosed herein are compositions comprising a blend of a first HDPE blend component and a second HDPE blend component, wherein the first HDPE component has a relatively higher density and lower molecular weight than the second HDPE component.

In some embodiments, the first HDPE component is present in the blend amount in the range of from 40 wt. % to 95 wt. %, from 50 wt. % to 90 wt. %, from 60 wt. % to 85 wt. %, or from 70 wt. % to 80 wt. %. Correspondingly, the second HDPE component is present in the blend amount in the range of from 5 wt. % to 60 wt. %, from 10 wt. % to 50 wt. %, from 15 wt. % to 40 wt. %, or from 20 wt. % to 30 wt. %. All weight percentages are based on the total weight of the first HDPE component and the second HDPE component.

In some embodiments, the blend composition has one of more of:
a) a density in the range of from 0.951 g/cm³ to 0.962 g/cm³ or from 0.956 g/cm³ to 0.960 g/cm³;
b) a melt index (I₅) in the range of from 0.60 g/10 min. to 2.50 g/10 min. or from 0.80 g/10 min. to 1.80 g/10 min.; and
c) an environmental stress crack resistance (“ESCR”) F50 in the range of from 24 hours to 1,000 hours in 100% Igepal and/or from 24 hours to 84 hours in 10% Igepal.

In some embodiments, the blend composition has one of more of:
a) a number average molecular weight (Mₙ) in the range of from 10,000 g/mol to 20,000 g/mol;
b) a weight average molecular weight (M_{w}) in the range of from 130,000 g/mol to 230,000 g/mol or from 156,000 g/mol to 194,000 g/mol;
c) a molecular weight distribution (MWD) in the range of from 8 to 20 or from 10 to 15;
d) a high load melt index (HLMI) in the range of from 15 g/10 min. to 45 g/10/min. or from 20 g/10 min. to 40 g/10/min.; and
e) a 2% flexural modulus in the range of from 165,000 psi (1,138 MPa) to 215,000 psi (1,482 MPa) or from 175,000 psi (1,207 MPa) to 205,000 psi (1,413 MPa).

In some embodiments, the blend composition has one of more of:
a) an overall polydispersity ratio (PDR) in the range of from 15 to 60 or;
b) a zero shear viscosity (ƒ₀) in the range of from 1.0×10⁶ to 3.0×10⁷;
c) a bulk intrinsic viscosity ([η]) in the range of from 1.5 to 2.5; and
d) a long chain branching index (LCBI) in the range of from 0.3 to 1.3.

In some embodiments, the first HDPE component and the second HDPE component are melt blended at a temperature in the range of from 150° C. to 250° C. to form the composition.

In some embodiments, the blend further comprises a primary antioxidant, a secondary antioxidant, or a combination thereof. In further embodiments, the primary antioxidant is present in the blend in an amount less than or equal to 1500 ppm and the secondary antioxidant is present in the blend in an amount less than or equal to 1500 ppm, wherein ppm values are based on the total weight of the first HDPE component and the second HDPE component.

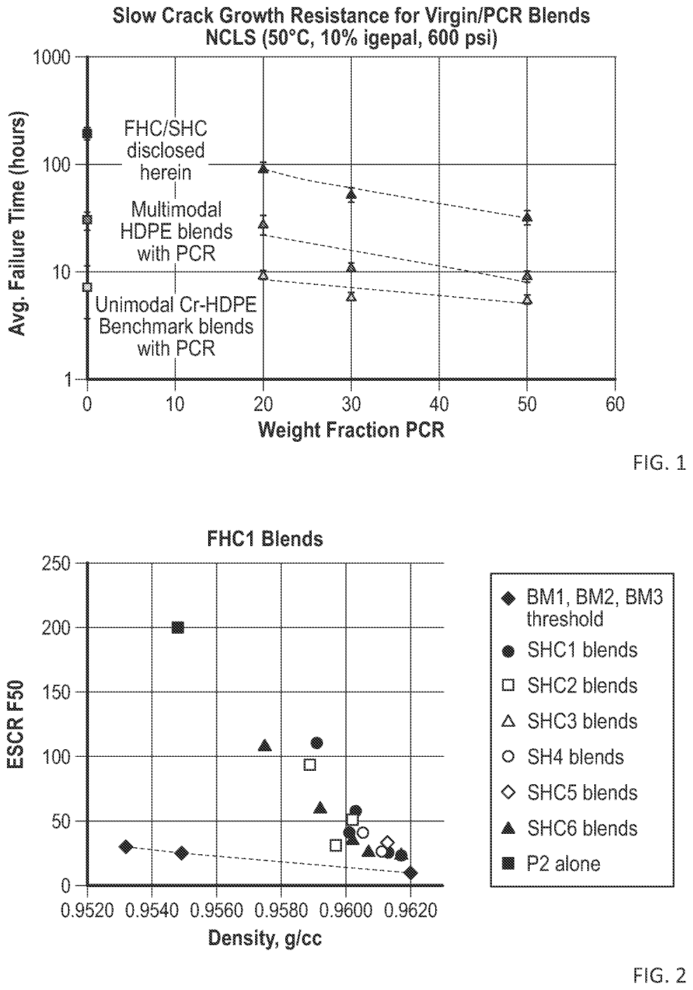

FIG. 1 shows the general trend of FHC/SHC blends as disclosed herein showing improved ESCR as compared to blend of HDPE recyclate with typical unimodal Cr-HDPE (produced using chromium catalyst) or typical multimodal HDPEs.

### First HDPE Blend Compositions

The first HDPE component has a density in the range of from 0.955 g/cm³ to 0.966 g/cm³, a melt index (I₅) in the range of from 1.50 g/10 min. to 3.50 g/10 min., and an ESCR F50 less than 24 hours in 100% Igepal.

In some embodiments, the first HDPE component has one or more of:
a) a number average molecular weight (Mₙ) in the range of from 8,000 g/mol to 20,000 g/mol or from 12,000 g/mol to 16,000 g/mol;
b) a weight average molecular weight (M_{w}) in the range of from 100,000 g/mol to 170,000 g/mol or from 115,000 g/mol to 145,000 g/mol;
c) a molecular weight distribution (MWD) in the range of from 5 to 14 or from 6 to 9;
d) a high load melt index (HLMI) in the range of from 35 g/10 min. to 70 g/10/min. or from 40 g/10 min. to 65 g/10/min.;
e) an average molecular weight (M_{z}) in the range of from 500,000 g/mol to 2,000,000 g/mol;
f) a z+1 average molecular weight (M_{z}+1) in the range of from 1,000,000 g/mol to 3,500,000 g/mol; and
g) a 2% flexural modulus in the range of from 170,000 psi (1,172 MPa) to 230,000 psi (1,586 MPa) or from 180,000 psi (1,241 MPa) to 210,000 psi (1,778 MPa).

In some embodiments, the first HDPE component has one or more of a zero shear viscosity (rho) in the range of from 1.1×10⁷ to 1.6×10⁷, a bulk intrinsic viscosity ([q]) in the range of from 1.40 to 1.75, a viscosity ratio in the range of from 0.800 to 1.100, and a long chain branching index (LCBI) in the range of from 0.6 to 2.0.

In some embodiments, the first HDPE component comprises one or more HDPE homopolymers, one or more HDPE copolymers, or a combination thereof.

In some embodiments, the first HDPE component comprises one or more HDPE recyclates, one or more virgin HDPEs, or a combination thereof.

In some embodiments, the first HDPE component comprises one or more HDPE homopolymer recyclates, one or more HDPE copolymer recyclates, or a combination thereof.

### Second HDPE Blend Compositions

The second HDPE component has a density in the range of from 0.947 g/cm³ to 0.954 g/cm³, a melt index (I₅) in the range of from 0.10 g/10 min. to 1.50 g/10 min., and an ESCR F50 of greater than or equal to 1,000 hours in 100% Igepal.

In some embodiments, the second HDPE component has one or more of a density at least 0.003 g/cm³ less than the density of the first HDPE component, an I₅ at least 0.02 g/10 min. lower than the I₅ of the first HDPE component; and an ESCR F50 in 100% Igepal at least 100 hours greater than the ESCR of the first HDPE component.

In some embodiments, the second HDPE component has one or more of:
a) a number average molecular weight (Mₙ) in the range of from 9,000 g/mol to 25,000 g/mol or from 12,000 g/mol to 22,000 g/mol;
b) a weight average molecular weight (M_{w}) in the range of from 150,000 g/mol to 350,000 g/mol or from 200,000 g/mol to 300,000 g/mol
c) a molecular weight distribution (MWD) in the range of from 5 to 40 or from 7 to 30;
d) a high load melt index (HLMI) in the range of from 5 g/10 min. to 40 g/10/min. or from 7 g/10 min. to 30 g/10/min.;
an average molecular weight (M_{z}) in the range of from 500,000 g/mol to 2,000,000 g/mol;
f) a z+1 average molecular weight (M_{z}+1) in the range of from 1,000,000 g/mol to 3,500,000 g/mol; and,g) a 2% flexural modulus in the range of from 120,000 psi (827 MPa) to 170,000 psi (1,172 MPa) or from 136,000 psi (938 MPa) to 146,000 psi (1,007 MPa).

In some embodiments, the second HDPE component has one or more of a zero shear viscosity (η₀) in the range of from 1.0×10⁵ to 1.0×10⁸, a bulk intrinsic viscosity ([η]) in the range of from 1.80 to 3.00, a viscosity ratio in the range of from 0.800 to 1.100, and a long chain branching index (LCBI) in the range of from 0.1 to 2.0.

In some embodiments, the second HDPE component comprises one or more HDPE homopolymers, one or more HDPE copolymers, or a combination thereof.

### High Density Polyethylene

In some embodiments, HDPE described herein comprise homopolymers and/or copolymers of units derived from ethylene and units derived from one or more of C₃-C₁₂ α-olefins. Such C₃-C₁₂ α-olefins include, but are not limited to, substituted or unsubstituted C₃ to C₁₂ alpha olefins such as propylene, butene, pentene, hexene, heptene, octene, nonene, decene, undecene, dodecane, and isomers thereof. When present, comonomers can be present in amounts up to 20 wt. %, 15 wt. %, 10 wt. %, or 5 wt. %.

Such ethylene homopolymers and/or copolymers can be produced in a suspension, solution, slurry, or gas phase process, using known equipment and reaction conditions. In some embodiments, polymerization temperatures range from about 0° C. to about 300° C. at pressures of from about 1 psig (6.9 kPag) to 1,000 psig (6.9 MPag).

Slurry or solution polymerization systems can utilize subatmospheric (below 1 atm or ˜14.7 psig, or from 1 to less than 14.7 psig), atmospheric pressures (about 1 atm or ˜14.7 psig) or superatmospheric pressures (above 1 atm or ˜14.7 psig, or greater than 1 to about 1,000 psig) and temperatures in the range of about 40° C. to about 300° C. An exemplary liquid phase polymerization system is described in U.S. Pat. No. 3,324,095, the disclosure of which is fully incorporated by reference herein. Liquid phase polymerization systems generally comprise a reactor to which olefin monomer and catalyst composition are added, and which contains a liquid reaction medium for dissolving or suspending the polyolefin. The liquid reaction medium may consist of the bulk liquid monomer or an inert liquid hydrocarbon that is nonreactive under the polymerization conditions employed. Although such an inert liquid hydrocarbon need not function as a solvent for the catalyst composition or the polymer obtained by the process, it usually serves as solvent for the monomers employed in the polymerization. Among the inert liquid hydrocarbons suitable for this purpose are isopentane, hexane, cyclohexane, heptane, benzene, toluene, and the like. Reactive contact between the olefin monomer and the catalyst composition should be maintained by constant stirring or agitation. The reaction medium containing the olefin polymer product and unreacted olefin monomer is withdrawn from the reactor continuously. The olefin polymer product is separated, and the unreacted olefin monomer and liquid reaction medium are recycled into the reactor.

Gas phase polymerization systems can utilize pressures in the range of from 1 psig (6.9 kPag) to 1,000 psig (6.9 MPag), 50 psig (344 kPag) to 400 psig (2.8 MPag), or 100 psig (689 kPag) to 300 psig (2.1 MPag), and temperatures in the range of from 30° C. to 130° C. or 65° C. to 110° C. Gas phase polymerization systems can be stirred or fluidized bed systems. In some embodiments, a gas phase, fluidized bed process is conducted by passing a stream containing one or more olefin monomers continuously through a fluidized bed reactor under reaction conditions and in the presence of catalyst composition at a velocity sufficient to maintain a bed of solid particles in a suspended condition. A stream containing unreacted monomer is withdrawn from the reactor continuously, compressed, cooled, optionally partially or fully condensed, and recycled into the reactor. Product is withdrawn from the reactor and make-up monomer is added to the recycle stream. As desired for temperature control of the polymerization system, any gas inert to the catalyst composition and reactants may also be present in the gas stream.

In some embodiments, a catalyst based on a Group VIB metal is used. In some embodiments the catalyst is a chromium-based catalyst. Such HDPE homopolymers and/or copolymers have some long-chain branching and a density in the range of from 0.940 g/cm³ to g/cm³.

In some embodiments, a Ziegler-Natta (ZN) catalyst is used. Such catalysts are based on a Group IVB transition metal compound and an organoaluminum compound (co-catalyst). Such transition metals, include, but not limited to, Ti, Zr, and Hf. Nonlimiting examples of ZN catalyst systems include TiCl₄+Et₃Al and TiCl₃+AlEt₂Cl. Such HDPE homopolymers and/or copolymers have some long-chain branching and a density in the range of from 0.940 g/cm³ to 0.970 g/cm³.

In some embodiments, HDPE described herein are prepared according to the processes and conditions found in U.S. Pat. Nos. 9,249,286 and 10,501,613, the disclosure of each is fully incorporated by reference herein. In other embodiments, HDPE described herein are prepared according to the processes and conditions found in PCT Pub. Nos. WO20140134193, WO20160206959, WO20160206958, WO20160206957, and WO20190121234, the disclosure of each is fully incorporated by reference herein. In yet other embodiments, the HDPE described herein are prepared according to the processes and conditions found in “Introduction to Industrial Polyethylene” by Dennis B. Malpass (2010), the disclosure of which is fully incorporated by reference herein. For example, an HDPE having the ESCR, zero shear viscosity, bulk intrinsic viscosity, and/or LCBI properties described herein can be prepared using a chromium catalyst under system conditions such as an operating pressure of about 590-620 PSI, an operating temperature of about 205-230F, a residence time of about 0.7-0.9 hours.

### Compounding Extruder

In some embodiments, the first HDPE component and the second HDPE component are fed to an extruder or mixer wherein the blend is subjected to compounding conditions. Compounding conditions are implemented in an extruder or mixer and are tailored for mixtures of specific polyolefins and optionally additives, such as, but not limited to a one or more primary antioxidants, one or more secondary antioxidants, and/or peroxides. Temperature, pressure, and shear force conditions are implemented in the second extruder or mixer sufficient to provide intimate mixing of the first HDPE component and the second HDPE component and optionally additives to produce a substantially homogeneous polymer blend of the first HDPE component and the second HDPE component. In some embodiments, compounding conditions comprise a temperature in the compounding zone of less than or equal to 300° C., less than or equal to 250° C. or less than or equal to 200° C. In some embodiments, temperatures in the compounding zone can be in the range of from 130° C. to 280° C., from 140° C. to 265° C., or from 150° C. to 250° C.

### Antioxidants

In some embodiments, primary and/or secondary antioxidants are added to stabilize the reactions for any exposure to oxygen during compounding.

Primary antioxidants react rapidly with peroxy and alkoxy radicals. Examples of primary antioxidants, sometimes termed “long-term antioxidants,” include phenolic antioxidants and hindered amine antioxidants, such as are disclosed in U.S. Pat. No. 6,392,056, the disclosure of which is incorporated herein in its entirety. Suitable primary antioxidants include, but are not limited to, Irganox™ antioxidants available from BASF, such as Irganox™ 1010, Irganox™ 1076, Irganox™ 1098, Irganox™ 1330, Irganox™ 1425 WL, Irganox™ 3114, Irganox™ 245 and Irganox™ 1135. Examples of suitable antioxidants, including phenolic antioxidants and hindered amine antioxidants, are described in U.S. Pat. No. 7,285,617, the disclosure of which is incorporated herein in its entirety.

Nonlimiting examples of primary antioxidants include 2,6-di-tert.butyl-4-methyl phenol, pentaerythrityl-tetrakis(3-(3′,5′-di-tert.butyl-4-hydroxyphenyl)-propionate, octadecyl 3-(3′,5′-di-tert.butyl-4-hydroxyphenyl)propionate, 1,3,5-tri-methyl-2,4,6-tris-(3,5-di-tert.butyl-4-hydroxyphenyl)benzene, 1,3,5-tris(3′,5′-di-tert.butyl-4′-hydroxybenzyl)-isocyanurate, bis-(3,3-bis-(4′-hydroxy-3′-tert.butylphenyl)butanic acid)-glycolester, N,N′-hexamethylene bis(3,5-di-tert.butyl-4-hydroxy-hydrocinnamamide, 2,5,7,8-Tetramethyl-2(4′, 8′,12′-trimethyltridecyl)chroman-6-ol, 2,2′-ethylidenebis(4,6-di-tert.butylphenol), 1,1,3-tris(2-methyl-4-hydroxy-5-tert.butylphenyl) butane, 1,3,5-tris(4-tert.butyl-3-hydroxy-2,6-dimethylbenzyl)-1,3,5-triazine-2,4,-6-(1H,3H,5H)-trione, 3,9-bis(1,1-dimethyl-2-(beta-(3-tert.butyl-4-hydroxy-5-methylphenyl) propionyloxy)ethyl)-2,4,8,10-tetraoxaspiro(5,5) undecane, 1,6-hexanediyl-bis(3,5-bis(1,1-dimethylethyl)-4-hydroxybenzene-propanoate-), 2,6-di-tert.butyl-4-nonylphenol, 4,4′-butylidenebis(6-tert.butyl-3-methylphenol), 2,2′-methylene bis(4-methyl-6-tert.butylphenol), and triethyleneglycol-bis-(3-tert.butyl-4-hydroxy-5 methylphenyl) propionate.

Secondary antioxidants, sometimes termed “short-term antioxidants,” can be added to the mixer/extruder at any convenient location. Secondary antioxidants are available commercially, such as the Irgafos™ antioxidants available from BASF, such as Irgafos™ 168, Irgafos™ 126, Irganox™ PS 800 and Irganox™ PS 802.

Examples of secondary antioxidants include, for example, aliphatic thiols and phosphites and phosphonites. Specific examples of secondary antioxidants include distearyl pentaerythritol diphosphite, isodecyl diphenyl phosphite, diisodecyl phenyl phosphite, tris(2,4-di-t-butylphenyl)phosphite, dilauryl-.beta., .beta.-thiodipropionate, .beta.-naphthyl disulfide, thiol-.beta.-naphthol, 2-mercaptobenzothiazole, benzothiazyl disulfide, phenothiazine, tris(p-nonylphenyl)phosphite, and zinc dimethyldithiocarbamate.

### Peroxides

In some embodiments, peroxide-modified resins can be used in the blends. Peroxide treatment conditions are implemented in an extruder. In some embodiments, peroxide treatment conditions mean subjecting a mixture of HDPE and peroxide to pressure, temperature, and shear force conditions sufficient for the peroxide to react with the HDPE to result in scission of the polymer chains and/or attachment of some polymer chains along the backbone of other polymer chains to produce long chain branching.

In some embodiments, the amount of a peroxide radical initiator added to the polyethylene composition is in the range of from 0.1 to 100 ppm by weight, alternatively from 0.5 to 100 ppm by weight, of peroxide to polyethylene composition. In some embodiments, the amount of a peroxide radical initiator added to the polyethylene composition is determined via rheology or via film testing. In some embodiments, the amount of radical initiator added to the polyethylene composition is determined via desired change in the rheological polydispersity ER. In some embodiments, the amount of radical initiator added to the polyethylene composition is determined via bubble stability testing.

In some embodiments, the first HDPE component, the second HDPE component, and/or the composition are treated with a peroxide under temperature, pressure, and shear force conditions in an extruder sufficient to increase the long chain branching and thereby the processability of the first polyethylene component, the second polyethylene component, and/or the composition, as the case may be. The blend composition can also be treated with peroxide during the process of blending the first HDPE component and the second HDPE component while under compounding conditions in and extruder or mixer. Improving processability of the first HDPE component and/or the second HDPE component prior to blending will improve processability of the composition after blending the components.

In some embodiments, the first HDPE component, the second HDPE component, and/or the composition are treated under compounding conditions as disclosed herein. In some embodiments, a temperature in the range of from 150° C. to 250° C. is believed, without wishing to be bound by any particular theory, favors long chain branching over chain scission such that the treated polymer has a higher degree of long chain branching and improved processability through higher melt strength. It is believed that more long chain branching occurs as the temperature is reduced from 250° C. to 150° C.

Nonlimiting examples of suitable radical initiators include one or more of the group consisting of 3-hydroxy-1,1-dimethylbutyl peroxyneodecanoate, a-cumyl peroxyneodecanoate, 2-hydroxy-1,1-dimethylbutyl peroxyneoheptanoate a-cumyl peroxyneoheptanoate, t-amyl peroxyneodecanoate, t-butyl peroxyneodecanoate, di(2-ethylhexyl) peroxydicarbonate, di(n-propyl) peroxydicarbonate, di(sec-butyl) peroxydicarbonate, t-butyl peroxyneoheptanoate, t-amyl peroxypivalate, t-butyl peroxypivalate, diisononanoyl peroxide, didodecanoyl peroxide, 3-hydroxy-1,1-dimethylbutylperoxy-2-ethylhexanoate, didecanoyl peroxide, 2,T-azobis(isobutyronitrile), di(3-carboxypropionyl) peroxide, 2,5-dimethyl-2,5-di(2-ethylhexanoylperoxy)hexane, dibenzoyl peroxide, t-amylperoxy 2-ethylhexanoate, t-butylperoxy 2-ethyl hexanoate, t-butyl peroxyisobutyrate, t-butyl peroxy-(cis-3-carboxy)propenoate, 1,1-di(t-amylperoxy)cyclohexane, 1,1-di(t-butylperoxy)-3,3,5-trimethylyclohexane, 1,1-di(t-butylperoxy) cyclohexane, OO-t-amyl O-(2-ethylhexyl) monoperoxycarbonate, OO-t-butyl O-isopropyl monoperoxycarbonate, OO-t-butyl O-(2-ethylhexyl) monoperoxycarbonate, polyether tetrakis(t-butylperoxycarbonate), 2,5-dimethyl-2,5-di(benzoylperoxy)hexane, t-amyl peroxyacetate, t-amyl peroxybenzoate, t-butyl peroxyisononanoate, t-butyl peroxyacetate, t-butyl peroxybenzoate, di-t-butyl diperoxyphthalate, 2,2-di(t-butylperoxy)butane, 2,2-di(t-amylperoxy)propane, n-butyl 4,4-di(t-butylperoxy)valerate, ethyl 3,3-di(t-amylperoxy)butyrate, ethyl 3,3-di(t-butylperoxy)butyrate, dicumyl peroxide, a,a′-bis(t-butylperoxy)diisopropylbenzene, 2,5-dimethyl-2,5-di(t-butylperoxy) hexane, di(t-amyl) peroxide, t-butyl a-cumyl peroxide, di(t-butyl) peroxide, 2,5-dimethyl-2,5-di(t-butylperoxy)-3-hexyne, dicetil peroxi-dicarbonato, 3,6,9-triethyl-3,6,9-trimethyl-1,4,7-triperoxonane, tert-butylperoxy 2-ethylhexyl carbonate, tert-butyl-peroxide n-butyl fumarate(benzoate), dimyristoyl peroxydiicarbonate, 3,3,5,7,7-pentamethyl-1,2,4-trioxepane, tert-butyl hydroperoxide, bis(4-t-butylcyclohexyl) peroxydicarbonate, and 1,2,4,5,7,8-hexoxonane,3,6,9-trimethyl-3,6,9-tris(ethyl and propyl derivatives).

### Compression Molding/Blow Molding

Compression molding is a fast-running plastics conversion process for caps and closures providing an efficient processing in terms of short cycle times and low energy consumption. This results in superior performance in terms of throughput and dimensional consistency of final items. With a lower conversion temperature, material is less prone to degradation.

Polyolefins useful in injection molding processes are typically also useful in compression molding processes, including, but not limited to, production of caps and closures. In some embodiments, polyolefins for use in compression molding have pronounced shear thinning and an over proportional lower flow resistance. Such characteristics help maintain high throughput and superior characteristics on the final item produced, such as, but not limited to ESCR.

Die swell is a common phenomenon in polyolefin extrusion processes in which a melted stream of polymeric material is forced through a die. Relevant processes include, but not limited to, compression molding, injection molding, and blow molding. Die swell is a phenomenon directly related to entropy and the relaxation of the polymer within the flow stream. A polymer melt flow stream has a constant rate before entering the die, and the polymer chains within the stream occupy a roughly spherical conformation, maximizing entropy. Extrusion through the die causes an increase in polymer flow rate due in part to the reduced cross-sectional area in the die. Polymer chains in the polymer melt flowing through the die start to lose their spherical shape due to the increased flow rate. The polymer chains become more elongated and physical entanglement among polymer chains is reduced to an extent dependent upon the length of time the polymer is in the die. When the polymer stream leaves the die, the remaining physical entanglements cause polymer chains in the die stream to regain a portion of their former shape and spherical volume, in order to return to the roughly spherical conformation that maximizes entropy.

Since polymer chain disentanglement is a kinetic process, a longer die and/or lower flow rate provide more time for disentanglement. Commercial motivations place both a lower limit on polymer flow rate through the die and an upper limit on the time that the polymer can stay in the die. Therefore, there is a need for polymers less prone to a high degree of polymer chain entanglement.

One challenge with using polymer recyclate in compression molding caps or closures is excessive die swell. The die swell causes problems between the extrudate slicing step and transfer into the mold. The polymer swells into a “mushroom” top that is challenging to transfer. This swell is a material property inherent to polymer recyclate streams, particularly those with low I₂ and/or I₂₁.

Die swell is related to the elasticity of the polymer due to the possibility of the polymer system to contract and expand. When a system of random coils of entangled polymer chains enters the capillary die under melt conditions, it undergoes a contraction which, after partially relaxing in the capillary, is partially recovered at the outlet, when no longer restrained by the capillary. Swelling upon discharge from the capillary can be very strong for polyolefins, such as, but not limited to, polyethylene and/or polypropylene. The effect of swelling is critical in some polymer processes, such as, but not limited to compression molding. Too much swell can cause processing problems and defects in molded products. ISO 11443 specifies a method for the measurement of die swell through the accessories of capillary rheometers.

Since polymer chain disentanglement is a kinetic process, a longer die and/or lower flow rate provide more time for disentanglement. Commercial motivations place both a lower limit on polymer flow rate through the die and an upper limit on the time that the polymer can stay in the die. Therefore, there is a need for polymers less prone to a high degree of polymer chain entanglement.

Typically, the die swell can also be decreased by using a polymer less susceptible to such chain entanglement such as, but not limited to, polymers having shorter average chain lengths, resulting in a higher I₂ and/or I₂₁. Polymer recyclate inherently contains a significant amount of long-chain polymer, thus decreasing the I₂ and/or I₂₁ of the polymer recyclate. Dry blending and/or compounding a high I₂ and/or I₂₁ virgin polymer with polymer recyclate, which low flow polyethylene is one way to increase the overall I₂ and/or I₂₁ of the blend. However, this approach offers limited improvement to the overall die swell due to the continued presence of long molecular weight chains in the polymer recyclate component of the blend.

Polymer recyclate that has been visbroken can produce a processed polymer recyclate having a I₂ and/or I₂₁ high enough to reduce die swell during compression molding to an acceptable level. Such processed polymer recyclate can be used in compression molding operation alone or in combination with one or more virgin polymers and/or one or more other processed polymer recyclates.

In some embodiments, the processed polyolefin recyclate useful in compression molding has a die swell (as measured by ASTM D3835 or ISO 11443) of less than or equal to 150%, less than or equal to 140%, less than or equal to 130%, less than or equal to 120%, less than or equal to 110%, or less than or equal to 100%.

In some embodiments, the processed polyolefin recyclate useful in compression molding has a die swell (as measured by ASTM D3835 or ISO 11443) of less than or equal to 200%, less than or equal to 190%, or less than or equal to 180%.

### Certain Embodiments

In some embodiments, a composition comprises a blend of a first HDPE component and a second HDPE component. The first HDPE component has a density in the range of from g/cm³ to 0.966 g/cm³, a melt index (15) in the range of from 1.50 g/10 min. to 3.50 g/10 min.; and an environmental stress crack resistance (“ESCR”) F50 less than 24 hours in 100% Igepal. The second HDPE component has i) a density in the range of from 0.947 g/cm³ to 0.954 g/cm³, an I₅ in the range of from 0.10 g/10 min. to 1.50 g/10 min., and an ESCR F50 of greater than or equal to 1,000 hours in 100% Igepal.

In some embodiments, the first HDPE component is present in the blend in an amount in the range of from 40 wt. % to 95 wt. %, from 50 wt. % to 90 wt. %, from 60 wt. % to 85 wt. %, or from 70 wt. % to 80 wt. %, and the second HDPE component is present in the blend in an amount in the range of from 5 wt. % to 60 wt. %, from 10 wt. % to 50 wt. %, from 15 wt. % to 40 wt. %, or from 20 wt. % to 30 wt. %, respectively. Weight percentages are based on the total weight of the first and second HDPE components.

In some embodiments of the composition, in addition to any one or more of the foregoing limitations, the composition is further characterized in that the second HDPE component has one or more of a density at least 0.003 g/cm 3 less than the density of the first HDPE component, an I₅ at least 0.02 g/10 min. lower than the I₅ of the first HDPE component, and/or an ESCR F50 in 100% Igepal at least 100 hours greater than the ESCR F50 in 100% Igepal at least 100 hours of the first HDPE component.

In some embodiments of the composition, in addition to any one or more of the foregoing limitations, the composition is further characterized in that the first HDPE component has one or more of:
a) a Mn in the range of from 8,000 g/mol to 20,000 g/mol or from 12,000 g/mol to 16,000 g/mol;
b) a M_{w} in the range of from 100,000 g/mol to 170,000 g/mol or from 115,000 g/mol to 145,000 g/mol;
c) a MWD in the range of from 5 to 14 or from 6 to 9;
d) a HLMI in the range of from 35 g/10 min. to 70 g/10/min. or from 40 g/10 min. to 65 g/10/min.; and
e) a 2% flexural modulus in the range of from 170,000 psi (1,172 MPa) to 230,000 psi (1,586 MPa) or from 180,000 psi (1,241 MPa) to 210,000 psi (1,778 MPa).

In some embodiments of the composition, in addition to any one or more of the foregoing limitations, the composition is further characterized in that the first HDPE component has one or more of:
a) a zero shear viscosity (rho) in the range of from 1.1×10⁷ to 1.6×10⁷;
b) a bulk intrinsic viscosity ([η]) in the range of from 1.40 to 1.75; and
c) a long chain branching index (LCBI) in the range of from 0.6 to 2.0.

In some embodiments of the composition, in addition to any one or more of the foregoing limitations, the composition is further characterized in that the second HDPE component has one or more of:
a) a Mₙ in the range of from 9,000 g/mol to 25,000 g/mol or from 12,000 g/mol to 22,000 g/mol;
b) a M_{w} in the range or from 150,000 g/mol to 350,000 g/mol or from 200,000 g/mol to 300,000 g/mol;
c) a MWD in the range of from 10 to 40 or from 15 to 30;
d) a HLMI in the range of from 5 g/10 min. to 40 g/10/min. or from 7 g/10 min. to 30 g/10/min.; and
e) a 2% flexural modulus in the range of from 120,000 psi (827 MPa) to 170,000 psi (1,172 MPa) or from 136,000 psi (938 MPa) to 146,000 psi (1,007 MPa).

In some embodiments of the composition, in addition to any one or more of the foregoing limitations, the composition is further characterized in that the second HDPE component has one or more of:
a) a zero shear viscosity (η₀) in the range of from 1.0×10⁵ to 1.0×10⁸;
b) a bulk intrinsic viscosity ([η]) in the range of from 1.80 to 3.00; and
c) a long chain branching index (LCBI) in the range of from 0.1 to 2.0.

In some embodiments of the composition, in addition to any one or more of the foregoing limitations, the composition is further characterized in that the blend composition has one or more of:
a) a density in the range of from 0.951 g/cm³ to 0.962 g/cm³ or from 0.956 g/cm³ to 0.960 g/cm³;
b) a melt index (I5) in the range of from 0.60 g/10 min. to 2.50 g/10 min. or from 0.80 g/10 min. to 1.80 g/10 min.; and
c) an environmental stress crack resistance (“ESCR”) F50 in the range of from 24 hours to 1,000 hours in 100% Igepal and/or from 24 hours to 84 hours in 10% Igepal.
d) a Mₙ in the range of from 10,000 g/mol to 20,000 g/mol;
e) a M_{w} in the range of from 130,000 g/mol to 230,000 g/mol or from 156,000 g/mol to 194,000 g/mol;
f) a MWD in the range of from 8 to 20 or from 10 to 15;
g) a HLMI in the range of from 15 g/10 min. to 45 g/10/min. or from 20 g/10 min. to 40 g/10/min;
h) an overall polydispersity ratio (PDR) in the range of from 15 to 60;
i) a zero shear viscosity (η₀) in the range of from 1.0×10⁶ to 3.0×10⁷;
j) a bulk intrinsic viscosity ([η]) in the range of from 1.5 to 2.5;
k) a long chain branching index (LCBI) in the range of from 0.3 to 1.3; and
l) a 2% flexural modulus in the range of from 165,000 psi (1,138 MPa) to 215,000 psi (1,482 MPa) or from 175,000 psi (1,207 MPa) to 205,000 psi (1,413 MPa).

In some embodiments of the composition, in addition to any one or more of the foregoing limitations, the first HDPE component comprises:
a) one or more HDPE homopolymers, one or more HDPE copolymers, or a combination thereof;
b) one or more HDPE recyclates, one or more virgin HDPEs, or a combination thereof; or
c) one or more HDPE homopolymer recyclates, one or more HDPE copolymer recyclates, or a combination thereof.

In some embodiments of the composition, in addition to any one or more of the foregoing limitations, the composition is further characterized in that prior to blending, the first HDPE component and/or the second HDPE component are treated with a peroxide, or during or after blending, the blend composition is treated with peroxide. Such peroxide treatment of the relevant component(s) or the composition is implemented at a temperature in the range of 150° C. to 270° C. under pressure and shear force conditions implemented in an extruder sufficient to increase the melt strength of the final blend composition as compared to a corresponding blend composition wherein the relevant component(s) or the composition are not so treated with peroxide.

In some embodiments of the composition, in addition to any one or more of the foregoing limitations, the second HDPE component comprises one or more virgin HDPE homopolymers, one or more virgin HDPE copolymers, or a combination thereof

In some embodiments of the composition, in addition to any one or more of the foregoing limitations, the first HDPE component and the second HDPE component are melt blended at a temperature in the range of from 150° C. to 270° C. In further embodiments, the blend further comprises one or more primary antioxidants, one or more a secondary antioxidant, or a combination thereof. In further embodiments, the total primary antioxidant and/or the total secondary antioxidant each can be present in the blend at up to 1,900 ppm, up to 1,500 ppm, or up to 1,000 ppm, based on the total weight of the first HDPE component and the second HDPE component.

The following examples illustrate the invention; however, those skilled in the art will recognize numerous variations within the spirit of the invention and scope of the claims. To facilitate a better understanding of the present invention, the following examples of preferred embodiments are given. In no way should the following examples be read to limit, or to define, the scope of the invention.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

The following examples use commercial HDPE compositions having a low melt index as proxies for HDPE recyclate feedstocks and/or a commercially available recyclate feedstock.

### Test Methods

Environmental Stress Crack Resistance (ESCR)—The resin environmental stress crack resistance (“ESCR”) was measured in accordance with ASTM-D 1693-01, Method B. In accordance with this test, the susceptibility of a resin to mechanical failure by cracking is measured under constant strain conditions, and in the presence of a crack accelerating agent, such as a soap or other wetting agent. Measurements were carried out on notched specimens, in a 10 percent, by volume, Igepal CO-630 (vendor Rhone-Poulec, NJ) aqueous solution, maintained at 50° C. Ten specimens were evaluated per measurement. The ESCR value of the resin was reported as F50, the calculated 50 percent failure time from the probability graph.

Densities are determined in accordance with ASTM D-4703 and ASTM D-1505/IS0-1183.

Die swell is determined herein by an internally developed test using a Goetfert Rheograph 25 capillary rheometer. The polymer melt is extruded from the die at a temperature of 190° C. at a shear rate of 525 s−1. The die swell of the extrudate is measured via a laser positioned at 78 mm below the bottom of the die. The die has an orifice diameter of 1 mm with an L/D of and a 90° entry angle. The extrudate strand is cut before measurement at a position of 120 mm below the bottom of the die.

High load melt index (“I₂₁”) was determined by ASTM D-1238-F (190° C./21.6 kg).

Shear rheological measurements are performed in accord with ASTM 4440-95a, which characterize dynamic viscoelastic properties (storage modulus, G′, loss modulus, G″ and complex viscosity, η*, as a function of oscillation frequency, w). A rotational rheometer (TA Instruments) is used for the rheological measurements. A 25 mm parallel-plate fixture was utilized. Samples were compression molded in disks (˜29 mm diameter and ˜1.3 mm thickness) using a hot press at 190° C. An oscillatory frequency sweep experiment (from 398.1 rad/s to 0.0251 rad/s) was applied at 190° C. The applied strain amplitude is ˜10% and the operating gap is set at 1 mm. Nitrogen flow was applied in the sample chamber to minimize thermal oxidation during the measurement.

Melt elasticity (“ER”) is determined as discussed in R. Shroff and H. Mavridis, “New Measures of Polydispersity from Rheological Data on Polymer Melts,” J. Applied Polymer Science 57 (1995) 1605. See also U.S. Pat. Nos. 7,238,754, 6,171,993 and 5,534,472 (col 10, lines 20-30), the teachings of which are incorporated herein by reference. Thus, storage modulus (G′) and loss modulus (G″) are measured. The nine lowest frequency points are used (five points per frequency decade) and a linear equation is fitted by least-squares regression to log G′ versus log G″. ER is then calculated from:

ER=(1.781×10⁻³)×G′

at a value of G″=5,000 dyn/cm². The same procedure and equation for the ER calculation was used for both linear and long-chain-branched polyolefins.

PDR, or “Overall Polydispersity Measure” is determined as discussed in R. Shroff and H Mavridis, “New Measures of Polydispersity from Rheological Data on Polymer Melts,” J. Applied Polymer Science 57 (1995) 1605, equation 27 on page 1619, with G*_{ref,1}=1.95*10⁴ dyn/cm² and logio(G*_{ref,3}G*_{ref,1})=2. The same procedure and equation for the PDR calculation was used for both linear and long-chain-branched polyolefins.

The ratio η*_{0.1}/η*₁₀₀ of complex viscosities, η*_{0.1}, at a frequency of 0.1 rad/sec and η*₁₀₀, at a frequency of 100 rad/sec, is used as an additional measure of shear sensitivity and thus rheological breadth, or polydispersity, of the polymer melt.

Melt index (“I₂”) was determined by ASTM D-1238-E (190° C./2.16 kg).

Melt index (“I₅”) was determined by ASTM D-1238 (190° C./5 kg).

Molecular weight distribution (“MWD”), which is also called M_{z}/M_{w}, as well as the molecular weight averages (number-average molecular weight, Mₙ weight-average molecular weight, M_{w}, z-average molecular weight, M_{z}, and z+1 average molecular weight, M_{z+}1) are determined using a high temperature Polymer Char gel permeation chromatography (“GPC”), also referred to as size exclusion chromatography (“SEC”), equipped with a filter-based infrared detector, IR5, a four-capillary differential bridge viscometer, and a Wyatt 18-angle light scattering detector. Mₙ, M_{w}, M_{z}, MWD, and short chain branching (SCB) profiles are reported using the IR detector, whereas long chain branch parameter, g′, is determined using the combination of viscometer and IR detector at 145° C. Three Agilent PLgel Olexis GPC columns are used at 145° C. for the polymer fractionation based on the hydrodynamic size in 1,2,4-trichlorobenzene (TCB) with 300 ppm antioxidant butylated hydroxytoluene (BHT) as the mobile phase. 16 mg polymer is weighted in a 10 mL vial and sealed for the GPC measurement. The dissolution process is obtained automatically (in 8 ml TCB) at 160° C. for a period of 1 hour with continuous shaking in an Agilent autosampler. 20 μL Heptane was also injected in the vial during the dissolution process as the flow marker. After the dissolution process, 200 μL solution was injected in the GPC column. The GPC columns are calibrated based on twelve monodispersed polystyrene (PS) standards (provided by PSS) ranging from 578 g/mole to 3,510,000 g/mole. The comonomer compositions (or SCB profiles) are reported based on different calibration profiles obtained using a series of relatively narrow polyethylene (polyethylene with 1-hexene and 1-octene comonomer were provided by Polymer Char, and polyethylene with 1-butene were synthesized internally) with known values of CH₃/1000 total carbon, determined by an established solution NMR technique. GPC one software was used to analyze the data. The long chain branch parameter, g′, is determined by the equation:

g′=[η]/[η]lin

where, [η] is the average intrinsic viscosity of the polymer that is derived by summation of the slices over the GPC profiles as follows:

$$[ η ] = \frac{\sum {{c}_{i} [ η ]}_{i}}{\sum {c}_{i}}$$

where cᵢ is the concentration of a particular slice obtained from IR detector, and [η]ᵢ is the intrinsic viscosity of the slice measured from the viscometer detector. [η]ₗᵢₙ is obtained from the IR detector using Mark-Houwink equation ([η]ₗᵢₙ=ΣKMᵢ^{α}) for a linear high density polyethylene, where Mᵢ is the viscosity-average molecular weight for a reference linear polyethylene, K and α are Mark-Houwink constants for a linear polymer, which are K=0.000374, α=0.7265 for a linear polyethylene and K=0.00041, α=0.6570 for a linear polypropylene.

Zero-shear viscosity, η₀, is determined using the Sabia equation fit of dynamic complex viscosity versus radian frequency, as described in of Shroff & Mavridis, (1999) “A Long Chain Branching Index for Essentially Linear Polyethylenes”, Macromolecules, 32, 8454-8464 (with focus on Appendix B), the disclosure of which is fully incorporated by reference herein in its entirety.

LCBI is determined using equation 13:

$$L C B I = \frac{{η}_{0}^{0.17}}{[ η ]} \frac{1}{4.8} - 1 \qquad ( 13 )$$

Equation 13 and its application are described in of Shroff & Mavridis, (1999) “A Long Chain Branching Index for Essentially Linear Polyethylenes”, Macromolecules, 32, 8454-8464, the disclosure of which is fully incorporated by reference herein in its entirety.

Long Chain Branching frequency, characterized by the ratio of Long Chain Branches per million carbon atoms, or LCB/10⁶ C, was determined by the method of Janzen & Colby (J. Janzen and R. H. Colby, “Diagnosing long-chain branching in polyethylenes”, Journal of Molecular Structure, Vol 485-486, 10 Aug. 1999, Pages 569-583), using eqs. (2-3) and the constants of Table 2 in the above reference. Specifically, the zero-shear viscosity at 190° C., η*₀, is determined by extrapolation of the complex viscosity data via the Sabia equation, as described separately. The weight-average-molecular weight, Mw, is determined via GPC. With these two parameters and the methodology of Janzen & Colby, the Long Chain Branching frequency, LCB/10⁶ C, can be determined numerically such that all 3 parameters (η₀, M_{w} and LCB/10⁶ C) satisfy eqs. (2-3) in the above reference. The Janzen & Colby methodology predicts that the ratio, η₀/η_{0,linear} of the zero-shear viscosity of the material, over the zero-shear viscosity of a perfectly linear polymer (LCB/10⁶ C=0) of the same average molecular weight, exhibits a maximum at a certain value of LCB/10⁶ C and therefore for every value of η₀/η_{0,linear}, there exist two levels, or values, of LCB/10⁶ C that such ratio is possible. For the purposes of the present calculations, the lowermost value of LCB/10⁶ C was always selected at the given ratio of η₀/η_{0,linear}.

### Raw Materials

Raw materials used herein are shown in TABLES 1-5, below. BM1-BM3 identify and show properties of benchmark polymers used to establish ESCR targets to be achieved by the HDPE blends disclosed herein. FHC1 and FHC2 identify and show properties of first HDPE components used in the HDPE blends disclosed herein. SHC1-SHC6 identify and show properties of second HDPE components used in the HDPE blends disclosed herein. P1-P7 identify and show properties of other HDPE polymers used for comparison to the HDPE blends disclosed herein.

TABLE 1 lists composition type and grade number of the raw materials along with a label identifier as used in the examples below in TABLES 2-25.

TABLE 1

| Label | Composition | Grade |
|---|---|---|
| BMI | HDPE | Petrothene LR732002¹ |
| BM2 | HDPE | Marlex ™ HHM5502BN³ |
| BM3/FHC1 | HDPE | Petrothene LM600700¹ |
| FHC2 | HDPE recyclate | EcoPrime² |
| SHC1 | HDPE bimodal copolymer | Alathon L4904¹ |
| SHC2 | HDPE bimodal copolymer | Alathon L4904LS |
| SHC3 | HDPE bimodal copolymer | Alathon L4930TC¹ |
| SHC4 | HDPE bimodal copolymer | Alathon L5008HP¹ |
| SHC5 | HDPE copolymer | Hyperzone HY4008¹ |
| SHC6 | HDPE copolymer | Hyperzone HY54907U¹ |
| P1 | HDPE copolymer | Hyperzone HY55430¹ |
| P2 | HDPE copolymer | GX5046 (pilot version of P1) |
| P3 | HDPE | Petrothene LP5100¹ |
| P4 | HDPE | Lupolen 4261AG |
| P5 | HDPE bimodal copolymer | Alathon L5440¹ |
| P6 | HDPE bimodal copolymer | Alathon L5332CP¹ |
| P7 | HDPE | Petrothene LT543522¹ |

¹Available from LyondellBasell, Houston, TX
²Available from Envision Plastics, Reidsville, NC
³Available from Chevron Phillips Chemical, Houston, TX

TABLE 2 lists the density, I₂, I₅, HLMI, ESCR F50, 100% Igepal, and die swell for the polymers identified in TABLE 1.

TABLE 2

| | | | | | ESCR F50, | Die |
|---|---|---|---|---|---|---|
| | Density, | I₂ | I₅ | HLMI, | 100% Igepal, | Swell |
| Polymer | (g/cc) | (dg/min) | (dg/min) | (dg/min) | (hrs.) | (%) |
| BM1 | 0.9532 | 0.36 | 1.70 | 36.9 | 30 | 185 |
| BM2 | 0.9549 | 0.376 | 1.63 | 34.9 | 24 | 182 |
| BM3/FHC1 | 0.9620 | 0.743 | 3.58 | 55 | 9.6 | 180 |
| FHC2 | 0.9605 | 0.617 | 2.91 | 57.4 | <24 | 175 |
| SHC1 | 0.9507 | 0.042 | 0.188 | 6.77 | >1000 | 134 |
| SHC2 | 0.9480 | 0.0239 | 0.149 | 5.95 | >1000 | 120 |
| SHC3 | 0.9492 | 0.273 | 1.06 | 24.5 | >1000 | 148 |
| SHC4 | 0.9521 | 0.08 | 0.38 | 14.9 | >1000 | 140 |
| SHC5 | 0.9491 | 0.0461 | 0.24 | 7.5 | >1000 | 153 |
| SHC6 | 0.9509 | 0.0728 | 0.36 | 7.9 | >1000 | 180 |
| P1 | 0.9531 | 0.258 | 1.08 | 25.1 | 340.8 | 163 |
| P2 | 0.9553 | 0.324 | 1.51 | 30.5 | 142 | 152 |
| P3 | 0.9500 | 0.11 | 0.51 | 11.5 | >1000 | 166 |
| P4 | 0.9450 | 0.075 | 0.33 | 6 | >1000 | 199 |
| P5 | 0.9540 | 0.035 | 1.70 | 37.45 | 50 | — |
| P6 | 0.9530 | 0.32 | 1.50 | 30.4 | 450 | — |
| P7 | 0.9540 | 0.35 | 1.60 | 32.3 | 60 | — |

TABLE 3 lists the M_{w}, Mₙ, M_{w}/Mₙ (MWD), M_{z}/M_{w}, M_{z}, and M_{z+1} for the polymers identified in TABLE 1.

TABLE 3

| | M_{w} | Mₙ | M_{w}/Mn | | M_{z} | M_{z+1} |
|---|---|---|---|---|---|---|
| Polymer | (g/mol) | (g/mol) | (MWD) | M_{z}/M_{w} | (g/mol) | (g/mol) |
| BM1 | 158,800 | 12,200 | 12.96 | 7.1 | 1,121,600 | 2,801,900 |
| BM2 | 148,100 | 19,200 | 7.92 | 5.7 | 848,000 | 2,291,500 |
| BM3/FHC1 | 131,000 | 19,200 | 6.83 | 5.4 | 710,400 | 1,643,300 |
| FHC2 | 129,200 | 16,500 | 7.83 | 4.9 | 638,400 | 1,458,400 |
| SHC1 | 302,000 | 10,700 | 28.14 | 5.1 | 1,547,200 | 2,820,400 |
| SHC2 | 282,000 | 11,200 | 25.1 | 4.9 | 1,389,200 | 2,546,400 |
| SHC3 | 199,400 | 10,600 | 18.8 | 5.0 | 999,400 | 1,994,600 |
| SHC4 | 252,500 | 10,600 | 23.78 | 5.6 | 1,411,200 | 2,698,100 |
| SHC5 | 273,300 | 11,200 | 24.42 | 5.1 | 1,397,900 | 2,647,300 |
| SHC6 | 274,100 | 17,800 | 15.41 | 5.3 | 1,463,600 | 2,861,300 |
| P1 | 201,300 | 13,900 | 14.46 | 5.0 | 1,014,300 | 2,084,300 |
| P2 | 205,700 | 12,400 | 16.54 | 5.1 | 1,040,000 | 1,971,400 |
| P3 | 203,000 | 12,000 | 16.95 | 5.6 | 1,129,600 | 2,688,700 |
| P4 | 286,800 | 20,100 | 14.26 | 5.7 | 1,647,400 | 3,239,000 |
| P5 | 179,100 | 19,200 | 12.67 | 5.7 | 1,028,900 | 2,142,500 |
| P6 | 206,400 | 19,200 | 15.38 | 5.6 | 1,146,000 | 2,467,200 |
| P7 | 155,200 | 19,200 | 14.17 | 6.4 | 989,200 | 2,557,000 |

TABLE 4 lists the ER, PDR, ETA0, ETA*100, ETA*1000, and IV for the polymers identified in TABLE 1.

TABLE 4

| | | | ETA0 (from | | | IV |
|---|---|---|---|---|---|---|
| Polymer | ER | PDR | PDR) | ETA*100 | ETA*1000 | (dL/g) |
| BM1 | 5.24 | 51.0 | 25,400,000 | 11,000 | 2,640 | 1.78 |
| BM2 | 5.19 | 36.4 | 21,300,000 | 11,700 | 2,809 | 1.76 |
| BM3/FHC1 | 3.66 | 18.7 | 1,370,000 | 10,200 | 2,750 | 1.62 |
| FHC2 | 4.80 | 32.9 | 12,900,000 | 10,400 | 2,701 | 1.61 |
| SHC1 | 2.51 | 24.9 | 9,308,000 | 25,700 | 4,330 | 2.81 |
| SHC2 | 4.23 | 48.0 | 47,260,000 | 25,500 | 4,353 | 2.70 |
| SHC3 | 2.64 | 17.3 | 841,000 | 14,900 | 3,439 | 2.12 |
| SHC4 | 2.84 | 34.5 | 5,370,000 | 18,700 | 3,320 | 2.45 |
| SHC5 | 2.44 | 22.0 | 6,283,000 | 25,400 | 4,563 | 2.64 |
| SHC6 | 3.58 | 28.7 | 16,600,000 | 23,900 | 4,921 | 2.68 |
| P1 | 3.64 | 17.9 | 2,320,000 | 15,900 | 3,772 | 2.16 |
| P2 | 4.05 | 22.7 | 2,990,000 | 13,800 | 3,320 | 2.17 |
| P3 | 5.32 | 32.8 | 26,500,000 | 21,200 | 4,428 | 2.18 |
| P4 | 3.92 | NR | 16,900,000 | 27,700 | 5,528 | 2.75 |
| P5 | 4.26 | 24.8 | 3,400,000 | 13,000 | 3,135 | 1.95 |
| P6 | 3.52 | 24.1 | 2,650,000 | 14,900 | 3,253 | 2.16 |
| P7 | 4.21 | 32.6 | 6,500,000 | 12,900 | 3,041 | 1.77 |

TABLE 5 lists the bulk comonomer, bulk IV, viscosity ratio, LCBI, and LCB/10 6 C for the polymers identified in TABLE 1.

TABLE 5

| | Bulk Comon. | Bulk IV | Viscosity | | |
|---|---|---|---|---|---|
| Polymer | (wt. %) | (dL/g) | Ratio | LCBI | LCB/10⁶ C |
| BM1 | 0.4 | 1.73 | 1.026 | 1.54 | 40.5 |
| BM2 | — | 1.80 | 0.989 | 0.87 | 27.3 |
| BM3/FHC1 | −0.2 | 1.58 | 1.027 | 0.66 | 28.6 |
| FHC2 | 1.2 | 1.54 | 1.046 | 1.54 | 93.2 |
| SHC1 | 1.6 | 2.81 | 1.000 | 0.31 | 5.29 |
| SHC2 | 2.1 | 2.69 | 0.997 | 0.83 | 9.86 |
| SHC3 | 1.8 | 2.02 | 0.949 | 0.19 | 6.73 |
| SHC4 | 2.6 | 2.32 | 0.949 | 0.44 | 7.02 |
| SHC5 | 2.3 | 2.68 | 1.015 | 0.28 | 6.01 |
| SHC6 | 2.5 | 2.65 | 0.991 | 0.54 | 8.02 |
| P1 | 1.8 | 1.91 | 0.882 | 0.51 | 9.72 |
| P2 | 1.8 | 1.80 | 0.830 | 0.67 | 10.0 |
| P3 | 0.1 | 2.20 | 0.992 | 1.02 | 19.48 |
| P4 | 0.9 | 2.87 | 0.958 | 0.43 | 7.21 |
| P5 | — | 1.81 | — | 0.70 | 15.2 |
| P6 | — | 2.07 | — | 0.42 | 9.5 |
| P7 | — | 1.77 | — | 0.95 | 28.2 |

### Examples 1-36

Examples 1-36 in TABLES 6-11 show the parameters and properties of blends of FHC1 with one or more amounts of each of SHC1, SHC2, SHC3, SHC4, SHC5, SHC6, P2, P3, P4, and P7.

TABLE 6 lists the weight percentages of polymers FHC1, SHC1, SHC2, SHC3, SHC4, SHC5, SHC6, P2, P3, P4, and P7 used in blend Examples 1-36. Properties of these blends are shown in TABLES 7-11.

TABLE 6

| Example | FHC1 | SHC1 | SHC2 | SHC3 | SHC4 | SHC5 | SHC6 | P2 | P3 | P4 | P7 |
|---|---|---|---|---|---|---|---|---|---|---|---|
| 1 | 85 | 15 | | — | — | — | — | — | — | — | — |
| 2 | 85 | — | — | — | 15 | — | — | — | — | — | — |
| 3 | 85 | — | — | — | — | 15 | — | — | — | — | — |
| 4 | 85 | — | — | — | — | — | 15 | — | — | — | — |
| 5 | 80 | 20 | — | — | — | — | — | — | — | — | — |
| 6 | 80 | — | 20 | — | — | — | — | — | — | — | — |
| 7 | 80 | — | — | — | 20 | — | — | — | — | — | — |
| 8 | 80 | — | — | — | — | 20 | — | — | — | — | — |
| 9 | 80 | — | — | — | — | — | 20 | — | — | — | — |
| 10 | 80 | — | — | — | — | — | — | — | 20 | — | — |
| 11 | 80 | — | — | — | — | — | — | — | — | 20 | — |
| 12 | 75 | 25 | — | — | — | — | — | — | — | — | — |
| 13 | 75 | — | 25 | — | — | — | — | — | — | — | — |
| 14 | 75 | — | — | — | 25 | — | — | — | — | — | — |
| 15 | 75 | — | — | — | — | 25 | — | — | — | — | — |
| 16 | 75 | — | — | — | — | — | 25 | — | — | — | — |
| 17 | 75 | — | — | — | — | — | — | 25 | — | — | — |
| 18 | 75 | — | — | — | — | — | — | — | — | — | 25 |
| 19 | 70 | 30 | — | — | — | — | — | — | — | — | — |
| 20 | 70 | — | 30 | — | — | — | — | — | — | — | — |
| 21 | 70 | — | — | 30 | — | — | — | — | — | — | — |
| 22 | 70 | — | — | — | 30 | — | — | — | — | — | — |
| 23 | 70 | — | — | — | — | 30 | — | — | — | — | — |
| 24 | 70 | — | — | — | — | — | 30 | — | — | — | — |
| 25 | 60 | 40 | — | — | — | — | — | — | — | — | — |
| 26 | 60 | — | 40 | — | — | — | — | — | — | — | — |
| 27 | 60 | — | — | 40 | — | — | — | — | — | — | — |
| 28 | 60 | — | — | — | 40 | — | — | — | — | — | — |
| 29 | 60 | — | — | — | — | 40 | — | — | — | — | — |
| 30 | 60 | — | — | — | — | — | 40 | — | — | — | — |
| 31 | 50 | — | — | 50 | — | — | — | — | — | — | — |
| 32 | 50 | — | — | — | — | — | — | 50 | — | — | — |
| 33 | 50 | — | — | — | — | — | — | — | — | — | 50 |
| 34 | 40 | — | — | 60 | — | — | — | — | — | — | — |
| 35 | 25 | — | — | — | — | — | — | 75 | — | — | — |
| 36 | 25 | — | — | — | — | — | — | — | — | — | 75 |

TABLE 7 lists the density, I₂, I₅, HLMI, ESCR F50, 100% Igepal, and die swell for the example blends as identified in TABLE 6. FIG. 2 shows a comparison of ESCR performance from data shown in TABLE 7.

TABLE 7

| | | | | | ESCR F50, | ESCR F50, | Die |
|---|---|---|---|---|---|---|---|
| | Density, | I₂ | I₅ | HLMI, | 100% Igepal, | 10% Igepal, | Swell |
| Example | (g/cc) | (dg/min) | (dg/min) | (dg/min) | (hrs.) | (hrs.) | (%) |
| 1 | 0.9613 | 0.435 | — | 41.6 | 26.4 | 24 | 177 |
| 2 | 0.9617 | 0.516 | — | 46.7 | 24 | 24 | 178 |
| 3 | 0.9613 | 0.469 | — | 42.4 | 33.6 | 24 | 178 |
| 4 | 0.9617 | 0.502 | — | 40.6 | 24 | 24 | 182 |
| 5 | 0.9601 | 0.376 | — | 38.1 | 40.8 | 31.2 | 177 |
| 6 | 0.9597 | — | 1.58 | 33.9 | 31.2 | 24 | 175 |
| 7 | 0.9611 | 0.44 | — | 42.8 | 26.4 | 31.2 | 178 |
| 8 | 0.9605 | 0.38 | 1.82 | 38.1 | 40.8 | 31.2 | 177 |
| 9 | 0.9607 | 0.424 | 1.88 | 35.0 | 26.4 | 24 | 183 |
| 10 | 0.9612 | — | 2.08 | 40.2 | 24 | 24 | 183 |
| 11 | 0.9600 | — | 1.67 | 17.4 | 28.8 | 24 | 200 |
| 12 | 0.9603 | 0.298 | — | 33.5 | 57.6 | 40.8 | 175 |
| 13 | 0.9602 | 0.325 | — | 35.7 | 50.4 | 45.6 | 165 |
| 14 | 0.9605 | 0.360 | — | 40.9 | 40.8 | 26.4 | 177 |
| 15 | 0.9594 | 0.319 | — | 34.9 | 79.2 | 48 | 176 |
| 16 | 0.9602 | 0.364 | — | 33.3 | 36 | 24 | 185 |
| 17 | 0.9610 | 0.662 | 2.76 | 49.9 | 24 | 24 | 179 |
| 18 | 0.9618 | 0.628 | 2.74 | 48.2 | 24 | 24 | 190 |
| 19 | 0.9600 | — | 1.11 | 28.6 | 110.4 | 43.2 | 180 |
| 20 | 0.9589 | — | 1.27 | 30.5 | 93.6 | 48 | 167 |
| 21 | 0.9585 | — | 2.23 | 43.5 | 40.8 | 24 | 173 |
| 22 | 0.9592 | — | 1.55 | 36.3 | 72 | 48 | 179 |
| 23 | 0.9593 | — | 1.27 | 28.9 | 88.8 | 55.2 | 178 |
| 24 | 0.9592 | — | 1.5 | 29.5 | 60 | 48 | 186 |
| 25 | 0.9579 | — | 0.68 | 20.0 | 489.6 | 86.4 | 176 |
| 26 | 0.9573 | — | 0.91 | 23.4 | 513.6 | 108 | 161 |
| 27 | 0.9573 | — | 1.94 | 38.7 | 57.6 | 48 | 170 |
| 28 | 0.9585 | — | 1.20 | 33.9 | 156 | 72 | 176 |
| 29 | 0.9579 | — | 1.05 | 24.5 | 200 | 105.6 | 173 |
| 30 | 0.9575 | — | 1.15 | 23.1 | 108 | 48 | 187 |
| 31 | 0.9567 | — | 1.76 | 37.2 | 129.6 | 57.6 | 166 |
| 32 | 0.9596 | 0.529 | 2.29 | 43.9 | 24 | 24 | 169 |
| 33 | 0.9596 | 0.537 | 2.36 | 43.8 | 24 | 24 | 189 |
| 34 | 0.9548 | — | 1.49 | 33.2 | 360 | 74.4 | 163 |
| 35 | 0.9559 | 0.427 | 1.95 | 39.2 | 52.8 | 40.8 | 162 |
| 36 | 0.9576 | 0.433 | 1.93 | 39.6 | 45.6 | 38.4 | 189 |

TABLE 8 lists the M_{w}, Mₙ, M_{w}/Mₙ (MWD), M_{z}/M_{w}, M_{z}, and M_{z+1} the example blends as identified in TABLE 6.

TABLE 8

| | M_{w} | Mₙ | M_{w}/Mₙ | | M_{z} | M_{z+1} |
|---|---|---|---|---|---|---|
| Example | (g/mol) | (g/mol) | (MWD) | M_{z}/M_{w} | (g/mol) | (g/mol) |
| 1 | 158,700 | 16,000 | 9.92 | 6.3 | 997,400 | 2,465,000 |
| 2 | 150,400 | 16,100 | 9.36 | 6.1 | 922,800 | 2,315,900 |
| 3 | 153,000 | 16,500 | 9.29 | 6.0 | 923,100 | 2,341,400 |
| 4 | 153,100 | 18,000 | 8.5 | 6.3 | 962,500 | 2,637,200 |
| 5 | 168,400 | 15,600 | 10.82 | 6.3 | 1,058,200 | 2,478,600 |
| 6 | 152,800 | 16,300 | 9.39 | 6.0 | 919,700 | 2,334,200 |
| 7 | 161,200 | 15,300 | 10.51 | 6.3 | 1,009,500 | 2,419,900 |
| 8 | 159,000 | 16,200 | 9.83 | 6.1 | 962,100 | 2,384,700 |
| 9 | 156,300 | 18,200 | 8.6 | 6.1 | 956,100 | 2,413,200 |
| 10 | 147,100 | 16,300 | 9.00 | 5.8 | 848,300 | 2,274,000 |
| 11 | 167,000 | 17,800 | 9.37 | 6.6 | 1,104,400 | 2,779,100 |
| 12 | 178,600 | 15,100 | 11.83 | 6.3 | 1,120,800 | 2,536,500 |
| 13 | 164,800 | 15,300 | 10.75 | 6.0 | 986,800 | 2,318,500 |
| 14 | 168,800 | 14,400 | 11.75 | 6.3 | 1,067,800 | 2,501,600 |
| 15 | 166,400 | 15,600 | 10.69 | 6.1 | 1,013,400 | 2,413,600 |
| 16 | 169,700 | 17,500 | 9.69 | 6.3 | 1,072,400 | 2,700,700 |
| 17 | 151,800 | 15,100 | 10.06 | 5.3 | 805,900 | 1,899,000 |
| 18 | 139,200 | 15,200 | 9.13 | 5.6 | 776,600 | 2,114,600 |
| 19 | 181,000 | 14,600 | 12.43 | 6.2 | 1,124,200 | 2,518,600 |
| 20 | 177,000 | 14,900 | 11.89 | 5.9 | 1,039,500 | 2,340,400 |
| 21 | 152,000 | 14,600 | 10.39 | 5.7 | 860,400 | 2,184,300 |
| 22 | 172,600 | 14,500 | 11.87 | 6.3 | 1,081,300 | 2,473,100 |
| 23 | 178,300 | 14,900 | 11.94 | 6.0 | 1,069,300 | 2,461,900 |
| 24 | 173,400 | 17,600 | 9.84 | 6.1 | 1,066,400 | 2,546,500 |
| 25 | 192,000 | 14,200 | 13.57 | 6.3 | 1,200,000 | 2,644,900 |
| 26 | 185,600 | 14,400 | 12.85 | 5.8 | 1,080,700 | 2,356,500 |
| 27 | 152,800 | 14,800 | 10.32 | 5.5 | 845,000 | 2,076,100 |
| 28 | 184,500 | 13,600 | 13.52 | 6.2 | 1,148,200 | 2,490,100 |
| 29 | 185,900 | 14,400 | 12.91 | 5.7 | 1,067,400 | 2,303,300 |
| 30 | 187,800 | 17,600 | 10.69 | 6.2 | 1,163,400 | 2,762,000 |
| 31 | 166,800 | 12,900 | 12.92 | 5.5 | 909,200 | 2,098,000 |
| 32 | 168,600 | 13,500 | 12.45 | 5.1 | 865,300 | 1,812,300 |
| 33 | 145,300 | 13,600 | 10.68 | 5.7 | 826,300 | 2,168,400 |
| 34 | 171,300 | 12,400 | 13.76 | 5.4 | 931,200 | 2,103,000 |
| 35 | 186,300 | 12,200 | 15.25 | 5.0 | 926,800 | 1,823,700 |
| 36 | 153,500 | 12,700 | 12.12 | 5.9 | 912,200 | 2,424,200 |

TABLE 9 lists the ER, PDR, ETA0, ETA*100, ETA*1000, and IV for the example

blends as identified in TABLE 6.

TABLE 9

| | | | ETA0 | | | | |
|---|---|---|---|---|---|---|---|
| | | | (from | | | | IV |
| Example | ER | PDR | PDR) | ETA*100 | ETA*1000 | log10(M_{w}) | (dL/g) |
| 1 | 3.73 | 30.6 | 4,310,000 | 12,000 | — | 5.20 | 1.8079 |
| 2 | 3.72 | 29.5 | 3,420,000 | 11,300 | — | 5.18 | 1.7483 |
| 3 | 3.70 | 29.2 | 3,510,000 | 11,700 | — | 5.18 | 1.7749 |
| 4 | 3.93 | 25.8 | 3,970,000 | 12,000 | — | 5.18 | 1.7793 |
| 5 | 3.73 | 36.2 | 4,900,000 | 11,800 | — | 5.23 | 1.8757 |
| 6 | 4.14 | 29.5 | 5,460,000 | 12,400 | 3,044 | 5.18 | 1.77 |
| 7 | 3.70 | 31.8 | 3,730,000 | 11,700 | — | 5.21 | 1.8211 |
| 8 | 3.70 | 31.7 | 3,740,000 | 11,900 | — | 5.20 | 1.8188 |
| 9 | 3.99 | 27.7 | 5,130,000 | 12,600 | — | 5.19 | 1.8061 |
| 10 | 3.98 | 24.3 | 4,110,000 | 12,400 | 3,103 | 5.17 | 1.74 |
| 11 | 4.11 | 26.3 | 6,160,000 | 13,500 | 3,300 | 5.22 | 1.88 |
| 12 | 3.69 | 37.1 | 5,590,000 | 12,700 | — | 5.25 | 1.9468 |
| 13 | 4.04 | 37.9 | 6,940,000 | 12,900 | — | 5.22 | 1.8576 |
| 14 | 3.65 | 34.9 | 4,370,000 | 12,400 | — | 5.23 | 1.871 |
| 15 | 3.58 | 33.8 | 4,690,000 | 12,900 | — | 5.22 | 1.8709 |
| 16 | 4.04 | 29.5 | 5,990,000 | 13,000 | — | 5.23 | 1.9028 |
| 17 | 3.66 | 20.3 | 1,870,000 | 11,500 | — | 5.18 | 1.7788 |
| 18 | 3.76 | 22.2 | 2,550,000 | 11,300 | — | 5.14 | 1.6805 |
| 19 | 3.58 | 34.4 | 4,800,000 | 14,600 | 3,306 | 5.26 | 1.97 |
| 20 | 4.01 | 35.9 | 8,670,000 | 14,600 | 3,320 | 5.25 | 1.95 |
| 21 | 3.35 | 20.0 | 1,430,000 | 12,600 | 3,076 | 5.18 | 1.77 |
| 22 | 3.76 | 35.9 | 4,340,000 | 12,200 | 2,853 | 5.24 | 1.90 |
| 23 | 3.54 | 31.6 | 3,880,000 | 14,500 | 3,334 | 5.25 | 1.96 |
| 24 | 3.99 | 28.0 | 7,080,000 | 14,200 | 3,433 | 5.24 | 1.93 |
| 25 | 3.71 | 38.1 | 4,950,000 | 14,700 | 3,257 | 5.28 | 2.04 |
| 26 | 4.34 | 42.8 | 14,600,000 | 15,300 | 3,370 | 5.27 | 2.01 |
| 27 | 3.38 | 19.8 | 1,550,000 | 12,900 | 3,143 | 5.18 | 1.78 |
| 28 | 3.64 | 37.3 | 3,670,000 | 13,900 | 3,102 | 5.27 | 1.98 |
| 29 | 3.28 | 30.2 | 2,970,000 | 15,900 | 3,515 | 5.27 | 2.02 |
| 30 | 3.92 | 30.2 | 8,740,000 | 15,400 | 3,596 | 5.27 | 2.04 |
| 31 | 3.10 | 19.0 | 1,230,000 | 13,600 | 3,160 | 5.22 | 1.88 |
| 32 | 3.69 | 20.7 | 2,030,000 | 12,300 | — | 5.23 | 1.9042 |
| 33 | 3.86 | 25.3 | 3,280,000 | 11,500 | — | 5.16 | 1.7231 |
| 34 | 3.03 | 18.2 | 1,210,000 | 14,300 | 3,268 | 5.23 | 1.91 |
| 35 | 3.81 | 21.6 | 2,410,000 | 13,000 | — | 5.27 | 2.036 |
| 36 | 3.94 | 27.1 | 4,430,000 | 12,600 | — | 5.19 | 1.7796 |

TABLE 10 lists the bulk comonomer, bulk IV, viscosity ratio, LCBI, LCB/10⁶ C, LCB-SHC, LCB-FHC, % FHC, linear LCB blend for the polymers identified in TABLE 6.

TABLE 10

| | Bulk | | | | | | | | Linear |
|---|---|---|---|---|---|---|---|---|---|
| | Comon. | Bulk IV | Viscosity | | LCB/10⁶ | LCB- | LCB- | % | LCB |
| Example | (wt. %) | (dL/g) | Ratio | LCBI | C. | SHC | FHC | FHC | Blend |
| 1 | −0.10 | 1.78 | 1.0143 | 0.80 | 23.1 | 5.29 | 28.57 | 85% | 25.1 |
| 2 | −0.10 | 1.72 | 1.0163 | 0.79 | 25.2 | 7.02 | 28.57 | 85% | 25.3 |
| 3 | 0.20 | 1.76 | 1.0088 | 0.76 | 24.2 | 6.01 | 28.57 | 85% | 25.2 |
| 4 | 0.00 | 1.75 | 1.0191 | 0.81 | 25.1 | 8.02 | 28.57 | 85% | 25.5 |
| 5 | 0.00 | 1.85 | 1.0141 | 0.78 | 20.2 | 5.29 | 28.57 | 80% | 23.9 |
| 6 | 0.5 | 1.73 | 0.974 | 0.94 | 27.96 | 9.9 | 28.57 | 80% | 24.8 |
| 7 | 0.00 | 1.79 | 1.0172 | 0.75 | 21.1 | 7.02 | 28.57 | 80% | 24.3 |
| 8 | 0.20 | 1.80 | 1.0097 | 0.74 | 25.1 | 6.01 | 28.57 | 80% | 24.1 |
| 9 | 0.10 | 1.78 | 1.0155 | 0.86 | 25.6 | 8.02 | 28.57 | 80% | 24.5 |
| 10 | −0.1 | 1.68 | 1.042 | 0.90 | 28.73 | 19.48 | 28.57 | 80% | 26.8 |
| 11 | −0.1 | 1.83 | 1.026 | 0.87 | 22.24 | 7.21 | 28.57 | 80% | 24.3 |
| 12 | 0.00 | 1.92 | 1.0151 | 0.75 | 17.9 | 5.29 | 28.57 | 75% | 22.7 |
| 13 | 0.20 | 1.83 | 1.0168 | 0.9 | 24.0 | 9.9 | 28.57 | 75% | 23.9 |
| 14 | 0.20 | 1.83 | 1.0198 | 0.75 | 19.4 | 7.02 | 28.57 | 75% | 23.2 |
| 15 | 0.30 | 1.86 | 1.0086 | 0.76 | 20.7 | 6.01 | 28.57 | 75% | 22.9 |
| 16 | 0.40 | 1.86 | 1.0225 | 0.83 | 21.1 | 8.02 | 28.57 | 75% | 23.4 |
| 17 | 0.00 | 1.61 | 1.1052 | 0.72 | 20.1 | 9.98 | 28.57 | 75% | 23.9 |
| 18 | −0.10 | 1.61 | 1.0410 | 0.81 | 29.2 | 28.16 | 28.57 | 75% | 28.5 |
| 19 | 0.8 | 1.90 | 0.966 | 0.72 | 16.43 | 5.29 | 28.57 | 70% | 21.6 |
| 20 | 0.9 | 1.90 | 0.976 | 0.91 | 20.84 | 9.9 | 28.57 | 70% | 23.0 |
| 21 | 0.8 | 1.71 | 0.968 | 0.54 | 18.25 | 6.7 | 28.57 | 70% | 22.0 |
| 22 | 0.9 | 1.85 | 0.974 | 0.74 | 18.19 | 7.02 | 28.57 | 70% | 22.1 |
| 23 | 1.3 | 1.93 | 0.987 | 0.63 | 16.04 | 6.01 | 28.57 | 70% | 21.8 |
| 24 | 1.1 | 1.90 | 0.985 | 0.84 | 20.81 | 8.02 | 28.57 | 70% | 22.4 |
| 25 | 0.9 | 2.00 | 0.980 | 0.65 | 14.11 | 5.29 | 28.57 | 60% | 19.3 |
| 26 | 0.9 | 1.96 | 0.977 | 1.03 | 21.15 | 9.9 | 28.57 | 60% | 21.1 |
| 27 | 0.8 | 1.72 | 0.964 | 0.56 | 18.48 | 6.7 | 28.57 | 60% | 19.8 |
| 28 | 1 | 1.94 | 0.978 | 0.61 | 14.35 | 7.02 | 28.57 | 60% | 20.0 |
| 29 | 1.4 | 1.99 | 0.988 | 0.51 | 13.14 | 6.01 | 28.57 | 60% | 19.5 |
| 30 | 1.4 | 2.00 | 0.981 | 0.82 | 17.73 | 8.02 | 28.57 | 60% | 20.4 |
| 31 | 1.1 | 1.81 | 0.961 | 0.42 | 13.17 | 6.7 | 28.57 | 50% | 17.6 |
| 32 | 0.30 | 1.66 | 1.1451 | 0.69 | 15.2 | 9.98 | 28.57 | 50% | 19.3 |
| 33 | 0.20 | 1.66 | 1.0364 | 0.84 | 27.7 | 28.16 | 28.57 | 50% | 28.4 |
| 34 | 1.2 | 1.84 | 0.962 | 0.39 | 12.13 | 6.7 | 28.57 | 40% | 15.5 |
| 35 | 0.60 | 1.70 | 1.1944 | 0.70 | 12.2 | 9.98 | 28.57 | 25% | 14.6 |
| 36 | 0.00 | 1.72 | 1.0336 | 0.87 | 25.8 | 28.16 | 28.57 | 25% | 28.3 |

TABLE 11 lists the ETA0 of SHC, IV of SHC, ETA0 of FHC, IV of FHC, ETA0 of blend, IV, and LCBI for the example blends as identified in TABLE 6.

TABLE 11

| | | | | | ETA0 of | IV of | LCBI of |
|---|---|---|---|---|---|---|---|
| | ETA0 of | IV of | ETA0 of | IV of | blend | blend | blend |
| Example | SHC | SHC | FHC | FHC | (theory) | (theory) | (theory) |
| 1 | 9,308,000 | 2.81 | 1,374,000 | 1.58 | 1,830,700 | 1.76 | 0.563 |
| 2 | 5,373,000 | 2.32 | 1,374,000 | 1.58 | 1,685,859 | 1.69 | 0.607 |
| 3 | 6,283,000 | 2.68 | 1,374,000 | 1.58 | 1,725,893 | 1.74 | 0.564 |
| 4 | 1,388,000 | 1.58 | 1,374,000 | 1.58 | 1,376,091 | 1.58 | 0.659 |
| 5 | 9,308,000 | 2.81 | 1,374,000 | 1.58 | 2,014,469 | 1.82 | 0.537 |
| 7 | 5,373,000 | 2.32 | 1,374,000 | 1.58 | 1,804,815 | 1.73 | 0.592 |
| 8 | 6,283,000 | 2.68 | 1,374,000 | 1.58 | 1,862,185 | 1.80 | 0.537 |
| 9 | 1,388,000 | 1.58 | 1,374,000 | 1.58 | 1,376,789 | 1.58 | 0.658 |
| 12 | 9,308,000 | 2.81 | 1,374,000 | 1.58 | 2,216,686 | 1.88 | 0.512 |
| 14 | 5,373,000 | 2.32 | 1,374,000 | 1.58 | 1,932,165 | 1.76 | 0.577 |
| 15 | 6,283,000 | 2.68 | 1,374,000 | 1.58 | 2,009,240 | 1.85 | 0.511 |
| 16 | 1,388,000 | 1.58 | 1,374,000 | 1.58 | 1,377,487 | 1.58 | 0.658 |
| 17 | 2,989,000 | 1.80 | 1,374,000 | 1.58 | 1,668,674 | 1.63 | 0.659 |
| 18 | 6,499,000 | 1.77 | 1,374,000 | 1.58 | 2,026,290 | 1.62 | 0.726 |
| 32 | 2,989,000 | 1.80 | 1,374,000 | 1.58 | 2,026,545 | 1.69 | 0.660 |
| 33 | 6,499,000 | 1.77 | 1,374,000 | 1.58 | 2,988,248 | 1.67 | 0.796 |
| 35 | 2,989,000 | 1.80 | 1,374,000 | 1.58 | 2,461,167 | 1.75 | 0.663 |
| 36 | 6,499,000 | 1.77 | 1,374,000 | 1.58 | 4,406,884 | 1.72 | 0.871 |

### Examples 42-61

Examples 42-61 in TABLES 12-17 show the parameters and properties of blends of FHC2 with one or more amounts of each of SHC1, SHC3, SHC4, SHC5, SHC6, P2, and P7.

TABLE 12 lists the weight percentages of polymers FHC2, SHC1, SHC3, SHC4, SHC5, SHC6, P2, and P7 used in blend Examples 42-61. Properties of these blends are shown in TABLES 13-17.

TABLE 12

| Example | FHC2 | SHC1 | SHC3 | SHC4 | SHC5 | SHC6 | P2 | P7 |
|---|---|---|---|---|---|---|---|---|
| 42 | 80 | 20 | — | — | — | — | — | — |
| 43 | 80 | — | — | — | 20 | — | — | — |
| 44 | 80 | — | — | — | — | 20 | — | — |
| 45 | 75 | — | — | — | — | — | 25 | — |
| 46 | 75 | — | — | — | — | — | — | 25 |
| 47 | 70 | 30 | — | — | — | — | — | — |
| 48 | 70 | — | 30 | — | — | — | — | — |
| 49 | 70 | — | — | 30 | — | — | — | — |
| 50 | 70 | — | — | — | 30 | — | — | — |
| 51 | 70 | — | — | — | — | 30 | — | — |
| 52 | 60 | — | 40 | — | — | — | — | — |
| 53 | 60 | — | — | — | — | — | — | — |
| 54 | 60 | — | — | — | 40 | — | — | — |
| 55 | 60 | — | — | — | — | 40 | — | — |
| 56 | 50 | — | 50 | — | — | — | — | — |
| 57 | 50 | — | — | — | — | — | 50 | — |
| 58 | 50 | — | — | — | — | — | — | 50 |
| 59 | 40 | — | 60 | — | — | — | — | — |
| 60 | 25 | — | — | — | — | — | 75 | — |
| 61 | 25 | — | — | — | — | — | — | 75 |

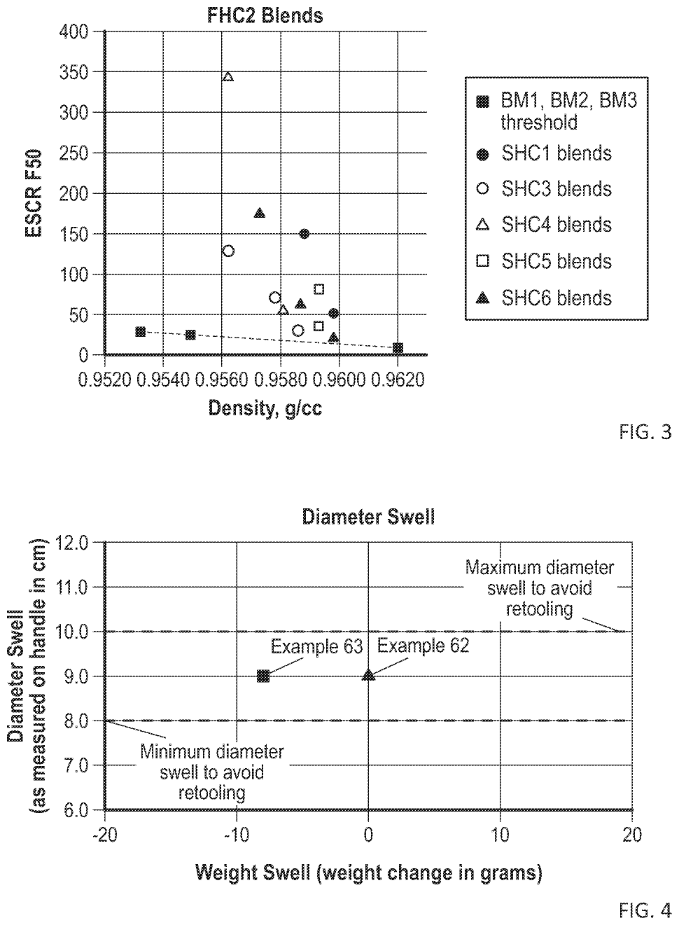

TABLE 13 lists the density, I₂, I₅, HLMI, ESCR F50, 100% Igepal, and die swell for the examples blends as identified in TABLE 12. FIG. 3 shows a comparison of ESCR performance from TABLE 13.

TABLE 13

| | | | | | ESCR | ESCR | |
|---|---|---|---|---|---|---|---|
| | | | | | F50, | F50, | |
| | | | | | 100% | 10% | Die |
| | Density, | I₂ | I₅ | HLMI, | Igepal, | Igepal, | Swell |
| Example | (g/cc) | (dg/min) | (dg/min) | (dg/min) | (hrs.) | (hrs.) | (%) |
| 42 | 0.9598 | — | 1.41 | 35.5 | 52.8 | 48 | 178 |
| 43 | 0.9593 | — | 1.49 | 35.9 | 36 | 24 | 175 |
| 44 | 0.9598 | — | 1.49 | 34.6 | 24 | 24 | 181 |
| 45 | 0.9576 | 0.479 | 2.46 | 48.5 | 24 | 24 | 178 |
| 46 | 0.9594 | 0.508 | 2.40 | 48.9 | 24 | 24 | 185 |
| 47 | 0.9588 | — | 0.95 | 29.7 | 148.8 | 52.8 | 176 |
| 48 | 0.9586 | — | 1.77 | 38.6 | 31.2 | 24 | 176 |
| 49 | 0.9581 | — | 1.25 | 32.8 | 55.2 | 31.2 | 173 |
| 50 | 0.9593 | | 1.31 | 35.9 | 81.6 | 45.6 | 176 |
| 51 | 0.9587 | — | 1.22 | 29.9 | 64.8 | 28.8 | 180 |
| 52 | 0.9578 | — | 1.64 | 36.9 | 72 | 38.4 | 170 |
| 53 | 0.9562 | — | 0.98 | 30.7 | 343.2 | 57.6 | 175 |
| 54 | 0.9568 | — | 0.797 | 21.8 | 1000 | 84 | 167 |
| 55 | 0.9573 | — | 0.977 | 25.2 | 177.6 | 48 | 180 |
| 56 | 0.9562 | — | 1.51 | 36.6 | 129.6 | 48 | 167 |
| 57 | 0.9576 | 0.437 | 1.98 | 43.5 | 24 | 24 | 170 |
| 58 | 0.9584 | 0.454 | 2.14 | 42.2 | 24 | 24 | 189 |
| 59 | 0.9545 | — | 1.48 | 31.4 | 432 | 72 | 163 |
| 60 | 0.9564 | 0.375 | 1.72 | 38.2 | 31.2 | 24 | 164 |
| 61 | 0.9608 | 0.415 | 1.92 | 39.2 | 48 | 24 | 191 |

TABLE 14 lists the M_{w}, Mₙ, M_{w}/Mₙ (MWD), M_{z}/M_{w}, M_{z}, and M_{z+1} the example blends as identified in TABLE 12.

TABLE 14

| | M_{w} | Mₙ | M_{w}/Mₙ | | M_{z} | M_{z+1} |
|---|---|---|---|---|---|---|
| Example | (g/mol) | (g/mol) | (MWD) | M_{z}/M_{w} | (g/mol) | (g/mol) |
| 42 | 169,000 | 14,500 | 11.68 | 5.9 | 1,001,200 | 2,096,500 |
| 43 | 164,600 | 14,500 | 11.36 | 5.9 | 977,400 | 2,405,400 |
| 44 | 165,900 | 16,300 | 10.18 | 6.1 | 1,007,900 | 2,572,500 |
| 45 | 153,200 | 13,900 | 11.02 | 5.2 | 802,800 | 1,807,700 |
| 46 | 141,000 | 14,100 | 9.98 | 5.6 | 787,100 | 2,094,200 |
| 47 | 187,200 | 13,800 | 13.60 | 5.9 | 1,112,800 | 2,267,100 |
| 48 | 155,900 | 13,500 | 11.55 | 5.6 | 868,600 | 2,071,100 |
| 49 | 183,800 | 13,200 | 13.90 | 6.0 | 1,103,600 | 2,271,500 |
| 50 | 188,200 | 14,100 | 13.37 | 5.6 | 1,045,600 | 2,104,600 |
| 51 | 175,100 | 16,200 | 10.82 | 5.9 | 1,037,000 | 2,431,300 |
| 52 | 162,600 | 13,000 | 12.50 | 5.3 | 861,400 | 1,846,500 |
| 53 | 188,900 | 12,800 | 14.75 | 6.1 | 1,153,300 | 2,462,900 |
| 54 | 194,300 | 13,500 | 14.43 | 5.6 | 1,084,200 | 2,297,900 |
| 55 | 188,900 | 16,400 | 11.49 | 6.0 | 1,128,500 | 2,527,200 |
| 56 | 169,600 | 12,600 | 13.50 | 5.3 | 903,700 | 1,973,200 |
| 57 | 167,600 | 12,900 | 13.03 | 5.1 | 861,100 | 1,784,600 |
| 58 | 146,600 | 13,300 | 11.05 | 5.7 | 830,200 | 2,149,600 |
| 59 | 176,400 | 12,400 | 14.23 | 5.3 | 926,400 | 2,055,200 |
| 60 | 185,300 | 12,200 | 15.21 | 5.0 | 922,000 | 1,820,000 |
| 61 | 153,300 | 12,300 | 12.51 | 5.8 | 887,400 | 2,250,700 |

TABLE 15 lists the ER, PDR, ETA0, ETA*100, ETA*1000, and IV for the example blends as identified in TABLE 12.

TABLE 15

| | | | ETA0 (from | | | | IV |
|---|---|---|---|---|---|---|---|
| Example | ER | PDR | PDR) | ETA*100 | ETA*1000 | log10(M_{w}) | (dL/g) |
| 42 | 4.39 | 48.7 | 18,700,000 | 13,200 | 3,059 | 5.23 | 1.89 |
| 43 | 4.34 | 42.7 | 12,300,000 | 12,600 | 2,984 | 5.22 | 1.86 |
| 44 | 4.55 | 38.1 | 18,900,000 | 13,700 | 3,314 | 5.22 | 1.88 |
| 45 | 4.58 | 30.9 | 9,190,000 | 11,600 | — | 5.19 | 1.7871 |
| 46 | 4.52 | 32.4 | 10,200,000 | 11,400 | | 5.15 | 1.6917 |
| 47 | 4.18 | 50.8 | 9,900,000 | 14,300 | 3,169 | 5.27 | 2.01 |
| 48 | 4.16 | 27.6 | 3,910,000 | 13,000 | 3,103 | 5.19 | 1.80 |
| 49 | 4.06 | 48.0 | 6,830,000 | 13,800 | 3,074 | 5.26 | 1.98 |
| 50 | 3.80 | 40.5 | 5,380,000 | 15,100 | 3,353 | 5.27 | 2.04 |
| 51 | 4.57 | 40.8 | 21,300,000 | 14,100 | 3,350 | 5.24 | 1.95 |
| 52 | 3.83 | 25.9 | 2,780,000 | 13,200 | 3,091 | 5.21 | 1.85 |
| 53 | 4.09 | 49.0 | 6,660,000 | 13,700 | 3,028 | 5.28 | 2.01 |
| 54 | 3.67 | 39.2 | 4,890,000 | 15,800 | 3,426 | 5.29 | 2.08 |
| 55 | 4.40 | 39.4 | 19,800,000 | 15,500 | 3,576 | 5.28 | 2.05 |
| 56 | 3.57 | 23.3 | 2,120,000 | 13,900 | 3,183 | 5.23 | 1.90 |
| 57 | 4.30 | 27.8 | 5,060,000 | 12,200 | — | 5.22 | 1.8941 |
| 58 | 4.27 | 30.9 | 7,620,000 | 12,200 | — | 5.17 | 1.7319 |
| 59 | 3.39 | 21.6 | 1,730,000 | 14,300 | 3,205 | 5.25 | 1.95 |
| 60 | 4.05 | 24.2 | 3,360,000 | 13,100 | — | 5.27 | 2.0276 |
| 61 | 4.14 | 29.7 | 6,090,000 | 12,600 | — | 5.19 | 1.7794 |

TABLE 16 lists the bulk comonomer, bulk IV, viscosity ratio, LCBI, LCB/10⁶ C, LCB-SHC, LCB-FHC, % FHC, linear LCB blend for the polymers identified in TABLE 12.

TABLE 16

| | Bulk | | | | | | | | Linear |
|---|---|---|---|---|---|---|---|---|---|
| | Comon. | Bulk IV | Viscosity | | LCB/10⁶ | LCB- | LCB- | % | LCB |
| Example | (wt. %) | (dL/g) | Ratio | LCBI | C. | SHC | FHC | FHC | “Blend” |
| 42 | 1.7 | 1.80 | 1.047 | 1.32 | 29.9 | 5.29 | 93.20 | 80% | 75.6 |
| 43 | 1.7 | 1.77 | 1.054 | 1.19 | 28.6 | 6.01 | 93.20 | 80% | 75.8 |
| 44 | 1.4 | 1.79 | 1.052 | 1.34 | 31.8 | 8.02 | 93.20 | 80% | 76.2 |
| 45 | 1.30 | 1.61 | 1.1125 | 1.29 | 32.8 | 9.98 | 93.20 | 75% | 72.4 |
| 46 | 1.10 | 1.61 | 1.0504 | 1.32 | 45.8 | 28.16 | 93.20 | 75% | 76.9 |
| 47 | 1.7 | 1.92 | 1.046 | 0.94 | 18.5 | 5.29 | 93.20 | 70% | 66.8 |
| 48 | 1.9 | 1.73 | 0.962 | 0.82 | 23.3 | 6.7 | 93.20 | 70% | 67.3 |
| 49 | 2 | 1.89 | 1.050 | 0.85 | 17.5 | 7.02 | 93.20 | 70% | 67.3 |
| 50 | 1.7 | 1.96 | 1.042 | 0.71 | 15.3 | 6.01 | 93.20 | 70% | 67.0 |
| 51 | 1.8 | 1.84 | 1.057 | 1.32 | 27.9 | 8.02 | 93.20 | 70% | 67.6 |
| 52 | 1.9 | 1.74 | 1.067 | 0.71 | 18.7 | 6.7 | 93.20 | 60% | 58.6 |
| 53 | 2.4 | 1.91 | 1.056 | 0.82 | 16.1 | 7.02 | 93.20 | 60% | 58.7 |
| 54 | 1.7 | 1.98 | 1.049 | 0.65 | 13.6 | 6.01 | 93.20 | 60% | 58.3 |
| 55 | 1.6 | 1.95 | 1.049 | 1.16 | 21.9 | 8.02 | 93.20 | 60% | 59.1 |
| 56 | 1.9 | 1.78 | 1.070 | 0.59 | 15.2 | 6.7 | 93.20 | 50% | 50.0 |
| 57 | 1.10 | 1.66 | 1.1423 | 0.99 | 20.7 | 9.98 | 93.20 | 50% | 51.6 |
| 58 | 0.60 | 1.65 | 1.0466 | 1.15 | 35.7 | 28.16 | 93.20 | 50% | 60.7 |
| 59 | 2 | 1.82 | 1.072 | 0.49 | 12.7 | 6.7 | 93.20 | 40% | 41.3 |
| 60 | 1.10 | 1.71 | 1.1854 | 0.79 | 13.8 | 9.98 | 93.20 | 25% | 30.8 |
| 61 | 0.60 | 1.72 | 1.0369 | 0.99 | 28.7 | 28.16 | 93.20 | 25% | 44.4 |

TABLE 17 lists the ETA0 of SHC, IV of SHC, ETA0 of FHC, IV of FHC, ETA0 of blend, IV, and LCBI for the example blends as identified in TABLE 12.

TABLE 17

| | | | | | ETA0 of | IV of | LCBI of |
|---|---|---|---|---|---|---|---|
| | ETA0 of | IV of | ETA0 of | IV of | blend | blend | blend |
| Example | SHC | SHC | FHC | FHC | (theory) | (theory) | (theory) |
| 42 | 9,308,000 | 2.81 | 12,870,000 | 1.54 | 12,062,411 | 1.79 | 1.152 |
| 43 | 6,283,000 | 2.68 | 12,870,000 | 1.54 | 11,150,549 | 1.77 | 1.152 |
| 44 | 1,388,000 | 1.58 | 12,870,000 | 1.54 | 8,244,052 | 1.55 | 1.328 |
| 45 | 2,989,000 | 1.80 | 12,870,000 | 1.54 | 8,934,400 | 1.60 | 1.278 |
| 46 | 6,499,000 | 1.77 | 12,870,000 | 1.54 | 10,849,146 | 1.60 | 1.371 |
| 47 | 9,308,000 | 2.81 | 12,870,000 | 1.54 | 11,677,823 | 1.92 | 0.998 |
| 48 | 841,000 | 2.02 | 12,870,000 | 1.54 | 5,677,325 | 1.68 | 1.004 |
| 49 | 5,373,000 | 2.32 | 12,870,000 | 1.54 | 9,903,074 | 1.77 | 1.100 |
| 50 | 6,283,000 | 2.68 | 12,870,000 | 1.54 | 10,378,990 | 1.88 | 0.996 |
| 51 | 1,388,000 | 1.58 | 12,870,000 | 1.54 | 6,598,145 | 1.55 | 1.231 |
| 52 | 841,000 | 2.02 | 12,870,000 | 1.54 | 4,321,809 | 1.73 | 0.856 |
| 53 | 5,373,000 | 2.32 | 12,870,000 | 1.54 | 9,074,733 | 1.85 | 0.980 |
| 54 | 6,283,000 | 2.68 | 12,870,000 | 1.54 | 9,660,819 | 2.00 | 0.858 |
| 55 | 1,388,000 | 1.58 | 12,870,000 | 1.54 | 5,280,839 | 1.56 | 1.137 |
| 56 | 841,000 | 2.02 | 12,870,000 | 1.54 | 3,289,935 | 1.78 | 0.720 |
| 57 | 2,989,000 | 1.80 | 12,870,000 | 1.54 | 6,202,292 | 1.67 | 1.050 |
| 58 | 6,499,000 | 1.77 | 12,870,000 | 1.54 | 9,145,607 | 1.65 | 1.219 |
| 59 | 841,000 | 2.02 | 12,870,000 | 1.54 | 2,504,431 | 1.82 | 0.595 |
| 60 | 2,989,000 | 1.80 | 12,870,000 | 1.54 | 4,305,653 | 1.74 | 0.848 |
| 61 | 6,499,000 | 1.77 | 12,870,000 | 1.54 | 7,709,559 | 1.71 | 1.080 |

### Examples 37-41

Examples 37-41 in TABLES 18-22 show the parameters and properties of blends of FHC1 and BM1 with amounts of each of SHC1, SHC3, SHC4, SHC5, and SHC6. In these three-component blends, FHC1 and BM1 form the first HDPE component, and the blend of FHC1 and BM1 has a density greater than 0.955 g/cm³.

TABLE 18 lists the weight percentages of polymers FHC1, SHC1, SHC3, SHC4, SHC5, SHC6, and BM1 used in blend Examples 37-41. Properties of these blends are shown in TABLES 19-22.

TABLE 18

| Example | FHC1 | SHC1 | SHC3 | SHC4 | SHC5 | SHC6 | BM1 |
|---|---|---|---|---|---|---|---|
| 37 | 25 | 25 | — | — | — | — | 50 |
| 38 | 25 | — | 25 | — | — | — | 50 |
| 39 | 25 | — | — | 25 | — | — | 50 |
| 40 | 25 | — | — | — | 25 | — | 50 |
| 41 | 25 | — | — | — | — | 25 | 50 |

TABLE 19 lists the density, I₂, I₅, HLMI, ESCR F50, 100% Igepal, and die swell for the examples blends as identified in TABLE 18.

TABLE 19

| | | | | | ESCR F50, | |
|---|---|---|---|---|---|---|
| | | | | | 100% | Die |
| | Density, | I₂ | I₅ | HLMI, | Igepal, | Swell |
| Example | g/cc | (dg/min) | (dg/min) | (dg/min) | (hrs.) | (%) |
| 37 (SHC1) | 0.9553 | — | 0.95 | 28.4 | 340.8 | 180 |
| 38 (SHC3) | 0.9547 | — | 1.61 | 39.5 | 79.2 | 180 |
| 39(SHC4) | 0.9557 | — | 1.19 | 35.3 | 264 | 181 |
| 40(SHC5) | 0.9545 | — | 0.98 | 28.0 | 380 | 177 |
| 41(SHC6) | 0.9553 | — | 1.20 | 30.2 | 139.2 | 186 |

TABLE 20 lists the M_{w}, Mₙ, M_{w}/Mₙ (MWD), M_{z}/M_{w}, M_{z}, and M_{z+1} the example blends as identified in TABLE 18.

TABLE 20

| | M_{w} | Mₙ | M_{w}/Mₙ | | M_{z} | M_{z+1} |
|---|---|---|---|---|---|---|
| Example | (g/mol) | (g/mol) | (MWD) | M_{z}/M_{w} | (g/mol) | (g/mol) |
| 37 | 183,500 | 12,700 | 14.41 | 6.5 | 1,188,600 | 2,625,900 |
| 38 | 159,300 | 12,800 | 12.42 | 6.1 | 974,500 | 2,324,700 |
| 39 | 177,500 | 12,600 | 14.06 | 6.6 | 1,165,200 | 2,632,000 |
| 40 | 178,500 | 13,000 | 13.70 | 6.2 | 1,111,800 | 2,498,400 |
| 41 | 176,900 | 14,600 | 12.14 | 6.5 | 1,147,900 | 2,751,400 |

TABLE 21 lists the ER, PDR, ETA0, ETA*100, ETA*1000, and IV for the example blends as identified in TABLE 18.

TABLE 21

| | | | ETA0 | | | | |
|---|---|---|---|---|---|---|---|
| | | | (from | | | | IV |
| Example | ER | PDR | PDR) | ETA*100 | ETA*1000 | log10(M_{w}) | (dL/g) |
| 37 | 4.16 | 52.0 | 10,600,000 | 13,900 | 3,043 | 5.26 | 1.96 |
| 38 | 4.08 | 30.8 | 4,330,000 | 12,600 | 2,955 | 5.20 | 1.80 |
| 39 | 4.11 | 48.2 | 8,540,000 | 13,100 | 2,948 | 5.25 | 1.92 |
| 40 | 4.03 | 43.2 | 7,660,000 | 13,800 | 3,103 | 5.25 | 1.94 |
| 41 | 4.29 | 39.3 | 13,500,000 | 13,600 | 3,177 | 5.25 | 1.94 |

TABLE 22 lists the bulk comonomer, bulk IV, viscosity ratio, LCBI, LCB/10⁶ C, LCB-SHC, LCB-FHC, % FHC, linear LCB blend for the polymers identified in TABLE 18.

TABLE 22

| | Bulk | | | | | | | | Linear |
|---|---|---|---|---|---|---|---|---|---|
| | Comon. | Bulk IV | Viscosity | | LCB/10⁶ | LCB- | LCB- | % | LCB |
| Example | (wt. %) | (dL/g) | Ratio | LCBI | C. | SHC | FHC | FHC | “Blend” |
| 37 | 0.9 | 1.94 | 1.010 | 0.94 | 20.0 | 5.29 | 28.57 | 25% | 11.1 |
| 38 | 0.9 | 1.77 | 1.018 | 0.81 | 22.9 | 6.7 | 28.57 | 25% | 12.2 |
| 39 | 0.9 | 1.89 | 1.014 | 0.92 | 20.6 | 7.02 | 28.57 | 25% | 12.4 |
| 40 | 0.8 | 1.94 | 1.003 | 0.84 | 19.6 | 6.01 | 28.57 | 25% | 11.7 |
| 41 | 0.7 | 1.91 | 1.011 | 1.05 | 23.7 | 8.02 | 28.57 | 25% | 13.2 |

### Diameter Swell

TABLE 23 shows a blend of FHC2 and SHC1 as disclosed herein compared to benchmark polymer BM1.

TABLE 23

| | FHC2 | SHC1 | BM1 | I₂ | HLMI | Melt Index |
|---|---|---|---|---|---|---|
| Example | (wt. %) | (wt. %) | (wt. %) | (dg/min.) | (dg/min.) | Ratio |
| 62 | — | — | 100 | 0.30 | 39 | 130 |
| 63 | 75 | 25 | — | 0.25 | 34 | 136 |

TABLE 24 shows the die swell performance of Example 63 compared to benchmark Example 62. Diameter swell and weight swell were measured on a Uniloy 350R2 single head blow molding machine. The machine was started up running virgin BM1 on a gallon center-fill bottle targeting 90 grams and 9.0 cm diameter swell as measured on the mold's graduated handle. BM1 is a widely used general purpose Cr-HDPE (produced using chromium catalyst) for blow molding and serves as a processability control for this test.

The FHC2/SHC1 blend was introduced “on top of” the BM1 control, mimicking a commercial-type conversion. Changes in bottle weight occur due to differences in parison thickness and tail flash length. This change in bottle weight is defined as the “weight swell”, and is the first thing an operator will notice when switching materials. The bottle weight is then changed back to 90 gram target by manually adjusting the die gap.

Once the trial material is back to target weight, the diameter swell is measured on the mold's graduated handle. Large deviations from target diameter swell can require tooling changes to make a wider or narrower parison. The target range for weight swell is −20 g to +20 g, and the target range for diameter swell is 8.0 cm to 10.0 cm. Example 63 was within the target range. This comparison is shown in tabular form in TABLE 24 and graphically in FIG. 4.

TABLE 24

| | Recip. | Recip. | Continuous | | |
|---|---|---|---|---|---|
| | Head | Drop | Head Pressure | Weight | Diameter |
| | Pressure | Time | (psi/kPa) | Swell¹ | Swell² |
| Example | (psi/kPa) | (sec) | (g) | (g) | (cm) |
| 62 | 1950 | 1.8 | 1,000 | 0 | 9.0 |
| 63 | 1840 | 1.9 | 1,100 | −8 | 9.0 |

¹weight change in grams
²as measured on handle in cm

For the sake of brevity, only certain ranges are explicitly disclosed herein. However, in addition to recited ranges, any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the processes, machines, film structures, composition of layers, means, methods, and/or steps described in the specification. As one of the ordinary skill in the art will readily appreciate from the disclosure of the present invention, processes, machines, film structures, composition of layers, means, methods, and/or steps, presently existing or later to be developed that perform substantially the same function or achieve substantially the same result as the corresponding embodiments described herein, may be utilized according to the present invention. Accordingly, the appended claims are intended to include within their scope such processes, machines, film structures, composition of layers, means, methods, and/or steps.

What is claimed is:

1. A composition comprising a blend of:
a) from 40 wt. % to 95 wt. % of a first high density polyethylene (“HDPE”) component having:
i) a density in the range of from 0.955 g/cm³ to 0.966 g/cm³;
ii) a melt index (I₅) in the range of from 1.50 g/10 min. to 3.50 g/10 min.; and
iii) an environmental stress crack resistance (“ESCR”) F50 less than 24 hours in 100% Igepal;
b) from 5 wt. % to 60 wt. % of a second HDPE component having:
i) a density in the range of from 0.947 g/cm³ to 0.954 g/cm³;
ii) an I₅ in the range of from 0.10 g/10 min. to 1.50 g/10 min.; and
iii) an ESCR F50 of greater than or equal to 1,000 hours in 100% Igepal;
wherein weight percentages are based on the total weight of the first HDPE component and the second HDPE component.

2. The composition of claim 1, wherein the first HDPE component is present in an amount in the range of from 50 wt. % to 90 wt. % and the second HDPE component is present in an amount in the range of from 10 wt. % to 50 wt. %.

3. The composition of claim 2, wherein the first HDPE component is present in an amount in the range of from 60 wt. % to 85 wt. % and the second HDPE component is present in an amount in the range of from 15 wt. % to 40 wt. %.

4. The composition of claim 1, wherein the second HDPE component has one or more of:
a) a density at least 0.003 g/cm³ less than the density of the first HDPE component;
b) an Is at least 0.02 g/10 min. lower than the Is of the first HDPE component; and
c) an ESCR F50 in 100% Igepal at least 100 hours greater than the ESCR F50 in 100% Igepal of the first HDPE component.

5. The composition of claim 1, wherein the first HDPE component has one or more of:
a) a number average molecular weight (Mₙ) in the range of from 8,000 g/mol to 20,000 g/mol;
b) a weight average molecular weight (M_{w}) in the range of from 100,000 g/mol to 170,000 g/mol;
c) a molecular weight distribution (MWD; M_{w}/Mₙ) in the range of from 5 to 14;
d) a high load melt index (HLMI) in the range of from 35 g/10 min. to 70 g/10/min.; and
e) a 2% flexural modulus in the range of from 170,000 psi (1,172 MPa) to 230,000 psi (1,586 MPa).

6. The composition of claim 1, wherein the first HDPE component has one or more of:
a) a zero shear viscosity (η₀) in the range of from 1.1×10⁷ to 1.6×10⁷;
b) a bulk intrinsic viscosity ([η]) in the range of from 1.40 to 1.75; and
c) a long chain branching index (LCBI) in the range of from 0.6 to 2.0.

7. The composition of claim 1, wherein prior to blending with the second HDPE component, the first HDPE component is treated with a peroxide at a temperature in the range of 150° C. to 270° C. under pressure and shear force conditions implemented in an extruder sufficient to increase the melt strength of the composition as compared to a corresponding blend of the first HDPE component and the second HDPE component wherein the first HDPE component is not so treated with peroxide.

8. The composition of claim 1, wherein the second HDPE component has one or more of:
a) a number average molecular weight (Mₙ) in the range of from 9,000 g/mol to 25,000 g/mol;
b) a weight average molecular weight (M_{w}) in the range of from 150,000 g/mol to 350,000 g/mol;
c) a molecular weight distribution (MWD) in the range of from 10 to 40;
d) a high load melt index (HLMI) in the range of from 5 g/10 min. to 40 g/10/min.; and
e) a 2% flexural modulus in the range of from 120,000 psi (827 MPa) to 170,000 psi (1,172 MPa).

9. The composition of claim 1, wherein the second HDPE component has one or more of:
a) a zero shear viscosity (η₀) in the range of from 1.0×10⁵ to 1.0×10⁸;
b) a bulk intrinsic viscosity ([η]) in the range of from 1.80 to 3.00; and
c) a long chain branching index (LCBI) in the range of from 0.1 to 2.0.

10. The composition of claim 1, wherein prior to blending with the first HDPE component, the second HDPE component is treated with a peroxide at a temperature in the range of 150° C. to 270° C. under pressure and shear force conditions implemented in an extruder sufficient to increase the melt strength of the composition as compared to a corresponding blend of the first HDPE component and the second HDPE component wherein the second HDPE component is not so treated with peroxide.

11. The composition of claim 1, wherein the blend has one or more of:
a) a density in the range of from 0.951 g/cm³ to 0.962 g/cm³;
b) a melt index (Is₅) in the range of from 0.60 g/10 min. to 2.50 g/10 min.; and
c) an environmental stress crack resistance (“ESCR”) F50 in the range of from 24 hours to 1,000 hours in 100% Igepal and/or from 24 hours to 84 hours in 10% Igepal.

12. The composition of claim 1, wherein the blend has one or more of:
a) a density in the range of from 0.956 g/cm³ to 0.960 g/cm³;
b) a melt index (I₅) in the range of from 0.80 g/10 min. to 1.80 g/10 min.; and
c) a number average molecular weight (Mₙ) in the range of from 10,000 g/mol to 20,000 g/mol;
d) a weight average molecular weight (M_{w}) in the range of from 130,000 g/mol to 230,000 g/mol;
e) a molecular weight distribution (MWD) in the range of from 8 to 20;
f) a high load melt index (HLMI) in the range of from 15 g/10 min. to 45 g/10 min.;
g) an overall polydispersity ratio (PDR) in the range of from 15 to 60;
h) a zero shear viscosity (η₀) in the range of from 1.0×10⁶ to 3.0×10⁷;
i) a bulk intrinsic viscosity ([η]) in the range of from 1.5 to 2.5;
j) a long chain branching index (LCBI) in the range of from 0.3 to 1.3; and
k) a 2% flexural modulus in the range of from 165,000 psi (1,138 MPa) to 215,000 psi (1,482 MPa).

13. The composition of claim 1, wherein the blend has one or more of:
a) a weight average molecular weight (Mw) in the range of from 156,000 g/mol to 194,000 g/mol;
b) a molecular weight distribution (MWD) in the range of from 10 to 15;
c) a high load melt index (HLMI) in the range of from 20 g/10 min. to 40 g/10/min.; and
d) a 2% flexural modulus in the range of from 175,000 psi (1,207 MPa) to 205,000 psi (1,413 MPa).

14. The composition of claim 1, wherein the first HDPE component comprises one or more HDPE homopolymers, one or more HDPE copolymers, or a combination thereof.

15. The composition of claim 14, wherein the first HDPE component comprises one or more HDPE recyclates, one or more virgin HDPEs, or a combination thereof.

16. The composition of claim 1, wherein during or after blending the first HDPE component and the second HDPE component, the blend is treated with a peroxide at a temperature in the range of 150° C. to 270° C. under pressure and shear force conditions implemented in an extruder sufficient to increase the melt strength of the composition as compared to a corresponding blend of the first HDPE component and the second HDPE component that is not so treated with peroxide.

17. The composition of claim 1, wherein the second HDPE component comprises one or more virgin HDPE homopolymers, one or more virgin HDPE copolymers, or a combination thereof.

18. The composition of claim 1, wherein the first HDPE component and the second HDPE component are melt blended at a temperature in the range of from 150° C. to 270° C.

19. The composition of claim 1, wherein the blend further comprises a primary antioxidant, a secondary antioxidant, or a combination thereof.

20. The composition of claim 19, wherein primary antioxidant is present in the blend in an amount less than or equal to 1,900 ppm and the secondary antioxidant is present in the blend in an amount less than or equal to 1,900 ppm, wherein ppm values are based on the total weight of the first HDPE component and the second HDPE component.
